(19) United States
(12) Patent Application Publication
(10) Pub. No.: US 2026/0030347 A1
(43) Pub. Date: Jan. 29, 2026

(54) Systems And Methods For Scalable Machine-Learning Deployment In Anomaly Detection

(71) Applicant: Cisco Technology, Inc., San Jose, CA (US)

(72) Inventors: Abhinav Mishra, San Francisco, CA (US); Kumar Sharad, Dresden (DE); Lei Chen, Santa Clara, CA (US)

(21) Appl. No.: 19/278,628

(22) Filed: Jul. 23, 2025

Related U.S. Application Data
(60) Provisional application No. 63/674,662, filed on Jul. 23, 2024.

(51) Int. Cl. G06F 21/55

(52) U.S. Cl. CPC G06F 21/552; G06F 2221/034

(57) ABSTRACT

Some implementations of the disclosure provided a method including operations of obtaining a data set, performing feature extraction operations resulting to extract features according to the first time window, performing aggregation operations for each feature of the extracted features with historical features resulting in a set of aggregated features, performing feature engineering on the aggregated features on a per entity basis resulting in generation of set of feature vectors, performing an anomaly detection process on the set of feature vectors including providing the set of feature vectors as input to a machine learning model resulting in generation of a label for each feature vector of the set of features, and performing a remedial action determination process including performing a threshold comparison with each label and, responsive to satisfaction of the threshold comparison by a first label, causing performance of one or more remedial actions.

### CROSS-REFERENCE TO RELATED APPLICATIONS

This application claims the benefit of priority to U.S. Provisional Application No. 63/674,662, filed Jul. 23, 2024, which is incorporated by reference in its entirety into this application.

### FIELD

The present disclosure relates to the deployment of machine-learning models configured to perform anomaly detection. More particularly, the present disclosure relates to a pipeline architecture for feature extraction from ingested data that enables scalable machine-learning deployment to detect anomalies within the ingested data.

### BACKGROUND

As storage of large amounts of data has become common place, data analytics has recently begun to be used to determine anomalies in this data. At times referred to as “behavior analytics,” this analysis of data may involve the detection of anomalies by analyzing patterns within the data to identify deviations that indicate suspicious or anomalous activities. Behavior analytics is typically utilized in the field of cybersecurity.

As a brief summary, one approach to user and entity behavior analytics (UEBA) may include the ingestion of data and the use of statistical or machine learning models to determine baseline or expected behavior patterns for a dataset, e.g., from one or more given data sources. Following the determination of a baseline set of behavior patterns, subsequent data is ingested from the one or more given data sources and analyzed against the baseline set of behavior patterns. When a deviation is identified, the deviation is flagged as an anomaly.

While UEBA plays a critical role in threat detection by identifying deviations from normal behavioral baselines. Typical UEBA solutions are not scalable and thus, impractical or inefficient as the number of detections or the number of user or devices grows. Typically, UEBA detection system work by collecting the last 30 days of data to compute baselines and then utilize machine learning models to identify any deviations associated therewith. Naturally, these behavioral machine learning models are very resource intensive. For example, if a customer is ingesting 3 TB/day, then a machine learning detection is using 90 TB of data to produce anomalies. Thus, what is needed is an efficient, scalable system and method for performing anomaly detections.

### BRIEF DESCRIPTION OF THE FIGURES

The above, and other, aspects, features, and advantages of several embodiments of the present disclosure will be more apparent from the following description as presented in conjunction with the following several figures of the drawings.

FIG. 1 is a block diagram illustrating an embodiment of a data processing environment including a data intake and query system including an anomaly detection subsystem in accordance with various embodiments of the disclosure;

FIG. 2 is a block diagram illustrating an embodiment of the components forming the anomaly detection subsystem deployed within the query system of FIG. 1 in accordance with various embodiments of the disclosure;

FIG. 3 is a flow diagram illustrating a high-level embodiment of an anomaly detection process implemented by the anomaly detection subsystem of FIGS. 1 and 2 in accordance with various embodiments of the disclosure;

FIG. 4A is an illustration of an example multi-layer anomaly detection pipeline formed by the components of the anomaly detection subsystem in accordance with various embodiments of the disclosure;

FIG. 4B is an illustration of portion of the multi-layer anomaly detection pipeline of FIG. 4A in accordance with various embodiments of the disclosure;

FIG. 5 is a flow diagram illustrating an embodiment of an anomaly detection process implemented by the anomaly detection subsystem deploying the multi-layer anomaly detection pipeline of FIG. 4 in accordance with various embodiments of the disclosure;

FIG. 6 is a flow diagram illustrating an example use case of an anomaly detection process implemented by the anomaly detection subsystem deploying the multi-layer anomaly detection pipeline of FIG. 4 in accordance with various embodiments of the disclosure;

FIG. 7A is a block diagram illustrating a set of user-level feature vectors being provided to machine learning model for label generation within an anomaly detection process in accordance with various embodiments of the disclosure;

FIG. 7B is a block diagram illustrating the set of user-level feature vectors shown in FIG. 7A with a peer group identifier being provided to machine learning model for label generation within an anomaly detection process in accordance with various embodiments of the disclosure;

FIG. 8 is a flow diagram illustrating a portion of an embodiment of an anomaly detection process implemented by the anomaly detection subsystem including generating labels for a set of peer-grouped user-level feature vectors through the deployment of machine learning models in accordance with various embodiments of the disclosure;

FIG. 9 is an illustration of an implementation of concepts performed by the anomaly detection subsystem of FIGS. 1 and 2 according to various embodiments of the disclosure;

FIG. 10 is a flow diagram illustrating an exemplary embodiment of an anomaly detection process implemented by the anomaly detection subsystem 150 of FIGS. 1 and 2 in accordance with various embodiments of the disclosure;

FIG. 11 is a diagram depicting various subsets of artificial intelligence in accordance with various embodiments of the disclosure;

FIG. 12 depicts different methods of machine-based learning in accordance with various embodiments of the disclosure;

FIG. 13 depicts a machine learning lifecycle in accordance with various embodiments of the disclosure;

FIG. 14 is a conceptual block diagram of a device suitable for configuration with logic of a multi-layer anomaly detection subsystem in accordance with various embodiments of the disclosure;

FIG. 15 is a block diagram illustrating an example computing environment that includes a data intake and query system in accordance with various embodiments of the disclosure;

FIG. 16 is a block diagram illustrating in greater detail an example of an indexing system of a data intake and query system, such as the data intake and query system of FIG. 15 in accordance with various embodiments of the disclosure;

FIG. 17 is a block diagram illustrating in greater detail an example of the search system of a data intake and query system, such as the data intake and query system of FIG. 15 in accordance with various embodiments of the disclosure; and

FIG. 18 illustrates an example of a self-managed network that includes a data intake and query system in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### I. Overview

Within some anomaly detections methods, a particular analysis or “detection” may comprise multiple levels of logic that may be scheduled for automated execution as different time intervals. As a concrete example, a single detection directed to detecting anomalous volumes of uploading network data from a particular device may involve multiple layers of logic with each layer configured to retrieve certain data and perform analyses such as a first layer of logic that is configured to retrieve data on an hourly basis and perform pre-processing, normalization, filtering, and feature extraction, where the extracted features are stored in first summary index. A second layer of logic may then retrieve those extracted features pertaining to the immediately preceding hour time window as well as the corresponding features extracted over the prior 23 hour time windows and aggregate those features into a daily set of features. A third layer of logic may be configured to perform feature engineering on the aggregated daily set of features on an entity (user or device) basis resulting in an entity-level feature vector. A fourth layer of logic may be configured to implement machine learning techniques and provide the entity-level feature vector to a machine learning model that is configured to determine whether the feature vector is indicative of an anomalous volume of uploaded network data. The following disclosure provides methods for scaling the number of detections that may be performed, e.g., machine learning models that may be utilized, be forming feature vectors from previously extracted and aggregated features.

As discussed below, by forming a directed acyclic graph (DAG) of computations, separate layers of a multi-layer anomaly detection subsystem may be configured to handle separate tasks such as data ingestion, filtering, and normalization as well as performance of higher-level operations such as feature engineering, modeling, scoring, and logging.

### II. General Considerations

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

### III. Example Embodiments

### A. Example System Architecture

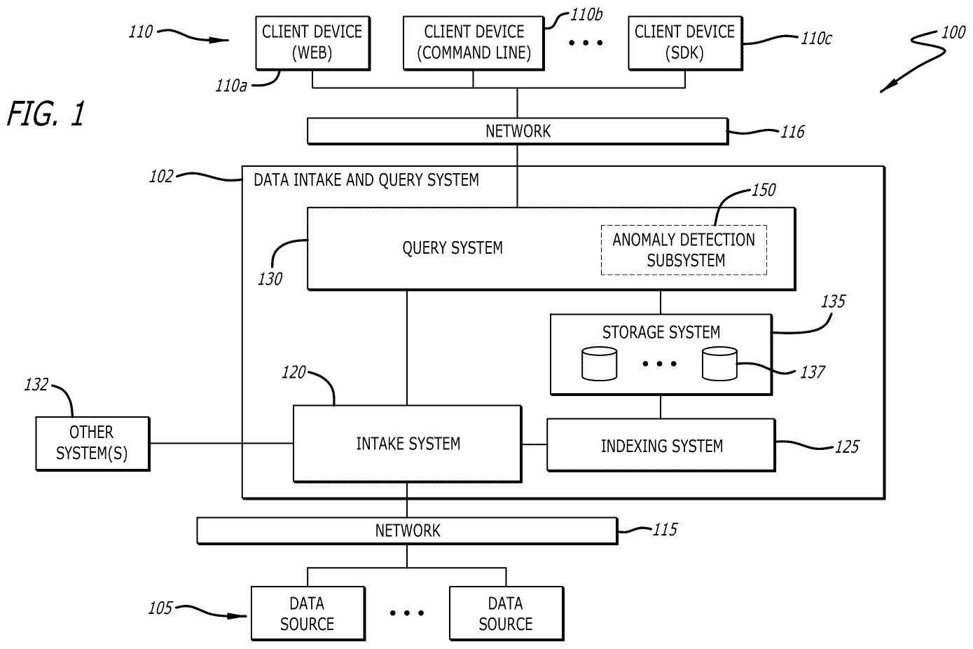

Referring now to FIG. 1, a block diagram illustrating an embodiment of a data processing environment 100 including a data intake and query system 102 comprising an anomaly detection subsystem 150 is shown in accordance with various embodiments of the disclosure. The data processing environment 100 features one or more data sources 105 (generically referred to as “data source(s)”) and client devices 110a, 110b, 110c (generically referred to as “client device(s) 110”) in communication with the data intake and query system 102 via networks 115 and 116, respectively. The networks 115, 116 may correspond to portions the same network or may correspond to different networks. Further, the networks 115, 116 may be implemented as private and/or public networks, one or more LANs, WANS, BLUETOOTH®, cellular networks, intranetworks, and/or internetworks using any of wired, wireless, terrestrial microwave, satellite links, etc., and may include the internet.

Each data source 105 broadly represents a distinct source of data that can be consumed by the data intake and query system 102. The data source(s) 105 may be positioned within the same geographic area or within different geographic areas such as different regions of a public cloud network. Examples of a data source 105 may include, without limitation or restriction, components or services that provide data files, directories of files, data sent over a network, event logs, registries, streaming data, etc. Herein, according to one embodiment of the disclosure, the data source(s) 105 provide streaming data (also referred to as a “data stream”) to an intake system 120 via the network 115, where the data stream may be time-series data and be processed by the anomaly detection subsystem 150.

The client device(s) 110 can be implemented using one or more computing devices in communication with the data intake and query system 102 and represent some of the different ways in which computing devices can submit queries to the data intake and query system 102. For example, a first client device 110a may be configured to communicate with the data intake and query system 102 over the network 116 via an internet (web) portal. In contrast, a second client device 110b may be configured to communicate with the data intake and query system 102 via a command line interface while a third client device 110c may be configured to communicate with the data intake and query system 102 via a software developer kit (SDK). As illustrated, the client device(s) 110 can communicate with and submit queries to the data intake and query system 102 in accordance with a plurality of different communication schemes.

The data intake and query system 102 may be configured to process and store data received from the data source(s) 105 and execute queries on the data in response to requests received from the client device(s) 110, perhaps requests as to detecting data drift. In the illustrated embodiment, the data intake and query system 102 includes the intake system 120, an indexing system 125, a query system 130, and/or a storage system 135 including one or more data stores 137. The data intake and query system 102 may include systems, subsystems, and components, other than the systems 120, 125, 130, 135 described herein.

As mentioned, the data intake and query system 102 may be configured to receive or subsequently consume (ingest) data from different sources 105. In some cases, various data sources 105 may be associated with one or more indexes, hosts, sources, sourcetypes, or users. The data intake and query system 102 may be configured to concurrently receive and process the data from data sources 105.

The intake system 120 may be configured to receive data from the data source(s) 105 in a variety of formats or structures. In some embodiments, the received data may correspond to streaming data as raw machine data, structured or unstructured data, correlation data, data files, directories of files, data sent over a network, event logs, sensor data, image and/or video data, etc. The intake system 120 can process the data based on the form in which it is received. In some cases, the intake system 120 can utilize one or more rules to process the data and to make the processed data available to downstream systems (e.g., the indexing system 125, query system 130, etc.).

Illustratively, the intake system 120 can enrich the received data. For example, the intake system 120 may add one or more fields to the data received from the data sources 105, such as fields denoting the host, source, sourcetype, or index associated with the incoming data. In certain embodiments, the intake system 120 can perform additional processing on the data, such as transforming structured data into unstructured data (or vice versa), identifying timestamps associated with the data, removing extraneous data, parsing data, indexing data, separating data, categorizing data, routing data based on criteria relating to the data being routed, and/or performing other data transformations, etc.

The intake system 120 may features one or more streaming data processors (not shown) for processing, where the streaming data processor(s) can be configured in operate in accordance with one or more rules to transform data and republish the data. In particular, the intake system 120 can function to conduct preliminary processing of data ingested at the data intake and query system 102. As such, the intake system 120 includes a forwarder that obtains data from one of the data source(s) 105, parses the data in accordance with one or more rules (e.g., data extraction rule(s), TA(s), etc.), and transmits the data to a data retrieval subsystem, which is configured to convert or otherwise format data provided by the forwarder into an appropriate format for inclusion at an intake ingestion buffer and transmit the data to the intake ingestion buffer for further processing.

Thereafter, the streaming data processor(s) may obtain data from the intake ingestion buffer, process the data, and republish the data to either the intake ingestion buffer (e.g., for additional processing) or to the output ingestion buffer, such that the data is made available to downstream components or systems such as the indexing system 125, query system 130 or other systems 132. In this manner, the intake system 120 may repeatedly or iteratively process data according to one or more rules, such as extraction rules (e.g., regex rules that may involve parsing) for example, where the data is formatted for use on the data intake and query system 102 or any other system. As discussed below, the intake system 120 may be configured to conduct such processing rapidly (e.g., in “real-time” with little or no perceptible delay), while ensuring resiliency of the data.

In some embodiments, as will be discussed further, the query system 130 may be configured with the anomaly detection subsystem 150, which may operate to execute a set of logic statements, e.g., queries, and in some instances, pipeline search query, which may be understood to be a sequence of commands chain together via a pipe symbol ‘|’, with each command processing results of the previously command. The set of logic statements may be executed according to a particular framework referred to herein as a multi-layer anomaly detection pipeline. Individual logic statements forming the set of set logics referenced above may be executed against ingested data that has been stored in the storage system 135 at particular intervals and according to certain time windows of ingested data. Advantageously, the logic statements serve to breakdown a large data retrieval into features, and further into feature vectors associated with a single entity, such as a device or a user. The logic statements may then include detecting anomalies on a per entity basis through the use of machine learning. As discussed throughout the application, the architecture of the anomaly detection subsystem 150 leads to substantial technological improvements including to the scalability of machine-learning based detections due to layered approach especially compared to the current art.

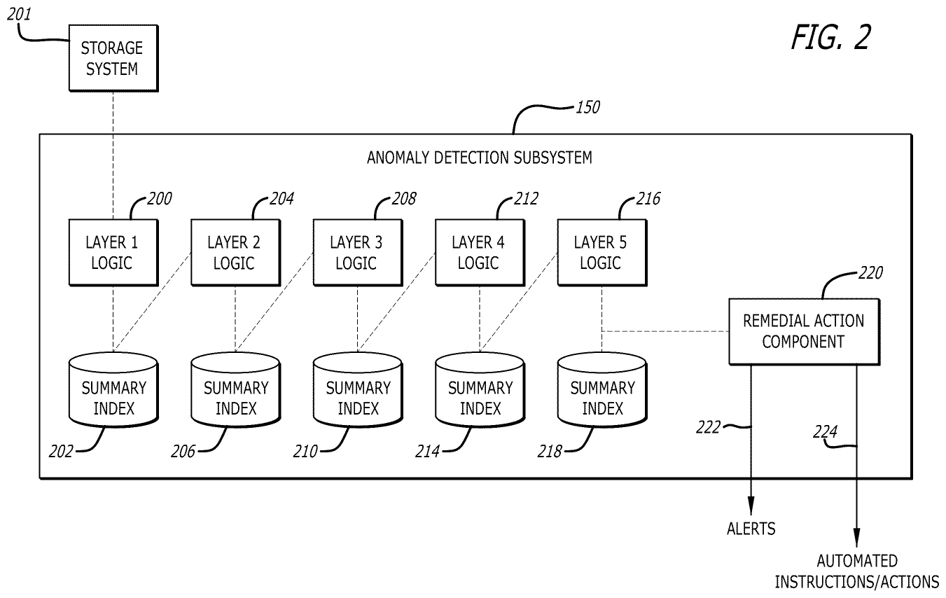

Referring to FIG. 2, a block diagram illustrating an embodiment of the components forming the anomaly detection subsystem deployed within the query system of FIG. 1 is shown in accordance with various embodiments of the disclosure. The anomaly detection subsystem 150 includes logic modules such as a layer 1 logic 200, a layer 2 logic 204, a layer 3 logic 208, a layer 4 logic 212, a layer 5 logic 216, and a remedial action component 220. Additionally, the anomaly detection subsystem 150 includes data stores (e.g., indexes) such as the summary indexes 202, 206, 210, and 214, and the detection index 218.

As illustrated, ingested data may be obtained by the logic 200 from a storage system 201. The logic 200 serves as the entry point to the anomaly detection subsystem 150 and may be responsible for data ingestion, validation, cleaning, normalization, and initial low-resolution feature engineering. The logic 200 may operate on ingested data such as raw data or data that has a format compliant with a standard data model framework with an example of which being a Common Information Model (CIM) utilized by Splunk, a Cisco Systems company. Examples of the ingested data include server logs (Windows Event Logs (System, Security, Application), Linux syslog (/var/log/messages)), application logs (Apache/Nginx access logs, Tomcat logs, JBoss logs), web server logs (access.log, error.log), database logs (alert logs, MySQL query logs), firewall logs (Cisco ASA, Palo Alto, Check Point logs), intrusion detection/prevention systems (IDS/IPS) data (from Snort, Suricata, Cisco Firepower), endpoint security tool data (CrowdStrike, Symantec, McAfee logs), antivirus/malware alerts, authentication and access logs (Active Directory, VPN logs (e.g., Cisco AnyConnect)), router and switch logs (Syslog from Cisco, Juniper), DHCP and DNS server logs, NetFlow/IPFIX data for network traffic analytics, IoT/OT devices (logs from sensors, industrial controllers, etc.), cloud service logs (AWS CloudTrail, AWS S3 access logs, Azure Activity Logs, GCP audit logs), software as a service (SaaS) application logs (Microsoft 365 audit logs, Salesforce event logs, Zoom meeting data), cloud infrastructure data (Kubernetes container logs, Docker daemon logs, system performance metrics (CPU usage, memory consumption, disk I/O), application performance metrics (response times, transaction counts), etc.

The logic 200 is configured to, upon execution by one or more processors, extract meaningful signals at a granular level (e.g., according to a predefined time, such as hourly). These extracted signals (features) include one or more of counts, presence of specific event types, combinations of fields such as user-device pairs, etc. The effective cardinality of this stage is approximately O(#users X #devices). Thus, executing the logic 200 over large time windows would lead to performance bottlenecks. By limiting the scope to smaller, more granular chunks of time (e.g., one hour), both scalability and near-real-time processing is achieved. The extracted and/or computed features generated by the logic 200 are written to the summary index 202, which serves as a feature store. Importantly, these features are shared across multiple downstream detections, promoting reuse, which reduces redundant computations. While in many instances, the layer 1 time window is an hour in length, the disclosure is not intended to be so limited and may be more granular (shorter window) or less granular (longer window). In some examples, when the layer 1 time window is one hour, the layer 1 features may be referred to as “hourly features.”

The logic 204 is configured to, upon execution by one or more processors, consume the layer 1 features stored in the summary index 202 and aggregate the layer 1 features over a second time frame that is greater than the chunks of time analyzed by the logic 200. For example, ingested data may be analyzed in one hour chunks by the layer 1 logic 200 while the layer 2 logic 204 analyzes the features from multiple one hour chunks, e.g., 24 such chunks. Stated differently, the logic 204 analyzes the layer 1 features over a 24 hour time window; however, the layer 2 time window is not limited to 24 hours. It should be understood that this is a rolling 24 hour time window. The processing performed by the logic 204 aggregates the layer 1 features stored in the summary index 202 on a per entity basis over the rolling time window, where an entity may represent a user or a device. In some examples, the logic 204 performs such aggregation through the execution of one or more queries. In some particular examples, the queries are specified using a search processing language (discussed in further detail below). For example, user-centric detections may execute a particular query specific for users, whereas device-centric detections execute a particular query specific for devices. The operations of the logic 204 significantly reduce data cardinality: from O(#users×#devices) to just O(#users) or O(#devices).

The processing of the logic 204 is configured to capture behavior summaries over the layer 2 time window (e.g., daily behavior summaries when the layer 2 time window is 24 hours). Examples of such behavior summaries may include total logon attempts, unique asset access, or time-based patterns and, as discussed below, serve as inputs to higher-level modeling features to the layer 3 logic 208. These layer 2 features are also written to a dedicated summary index, the summary index 206, forming a clean and persistent abstraction for downstream use. In some examples, when the layer 2 time window is 24 hours, the layer 2 features, which represent an aggregation of the layer 1 features over the past 24 hours, may be referred to as “daily features.”

One important aspect to note is that the layer 2 features extracted and/or computed by the logic 204 should be understood as features that are rolling and mergeable. As discussed above, in layer 1, layer 1 features are extracted or computed at granular intervals (e.g., hourly) and are then stored in the summary index 202. In subsequent layers, e.g., layer 2, the layer 1 features are then merged to recreate longer features such as daily, weekly, or monthly behaviors. While the layer 1 features are extracted or computed individually on high resolution time data, once they are merged, the aggregated features match the exact query on the original time window. This concept may be referred to as the mergeability of features. Considering an illustrative example, if each hour window (layer 1 time window) represents a feature “data_upload,” then for a 24 hour period (layer 2 time window), the anomaly detection subsystem 150 can compute a 1 hour data_upload feature for every hour and sum the past twenty four 1 hour data_upload features to obtains the results of the past day. In a more complex situation, the anomaly detection subsystem 150 obtains probabilistic distributions for each hour and combines the probabilistic distributions over 24 hours to obtain the resulting daily distribution.

It should also be understood that not all features are mergeable. For example, a feature such as distinct count is not additive and hence cannot be merged. However, there are probabilistic and approximate data sketches that solve some of these problems, for example the probabilistic data structure HyperLogLog Sketch may be used to estimate the distinct count (e.g., the cardinality). More complex tasks such as mergeable quantile require more theoretical frameworks.

The logic 208 is configured to, upon execution by one or more processors, perform deep feature engineering by operating over a third time window (a layer 3 time window), which may be in some examples 30 days of layer 2 features (e.g., daily aggregates) per entity, e.g., capturing monthly aggregated features per entity. The capture of aggregated layer 2 features (referred to as layer 3 features) allows the anomaly detection subsystem 150 to capture long-term trends, behavior baselines, and statistical variation. The raw data cardinality at layer 3 is O(30×#users) or O(30×#devices); however, the logic 208 generates a single feature vector per entity, which due to the aggregation of past layers' features and computations, encapsulates both historical context and recent behavior per entity. This single entity feature vector represents a behavioral fingerprint for a singular entity that may be used in anomaly detection. The single entity feature vectors (layer 3 feature vectors) are also written to a dedicated summary index, the summary index 2010, continuing the clean and persistent abstraction for downstream use.

The logic 212 is configured to, upon execution by one or more processors, obtain the entity feature vectors (layer 3 feature vectors), e.g., from the summary index 210, and perform anomaly detection processes. Examples of the anomaly detection processes may include statistical thresholding methods, behavioral baselining, density-based methods, and/or time-series forecasting. Statistical thresholding methods may include identifying data points that lie outside of a statistical range. Behavioral baselining includes determining a baseline (normal behavior) for a feature (may be by entity, peer group, enterprise, etc.) and assessing current feature values to the baseline. Density-based methods identify low-density regions (outliers) in a given feature set. Time-series forecasting detects anomalies by comparing actual to predicted features values over time. The analyses performed by the execution of the logic 212 results in the generation of a scoring for each anomaly detection performed with the scoring results being stored in the summary index 214. Additionally, baselines, thresholds, and/or activities computed by logic 212 may be logged in the summary index 214.

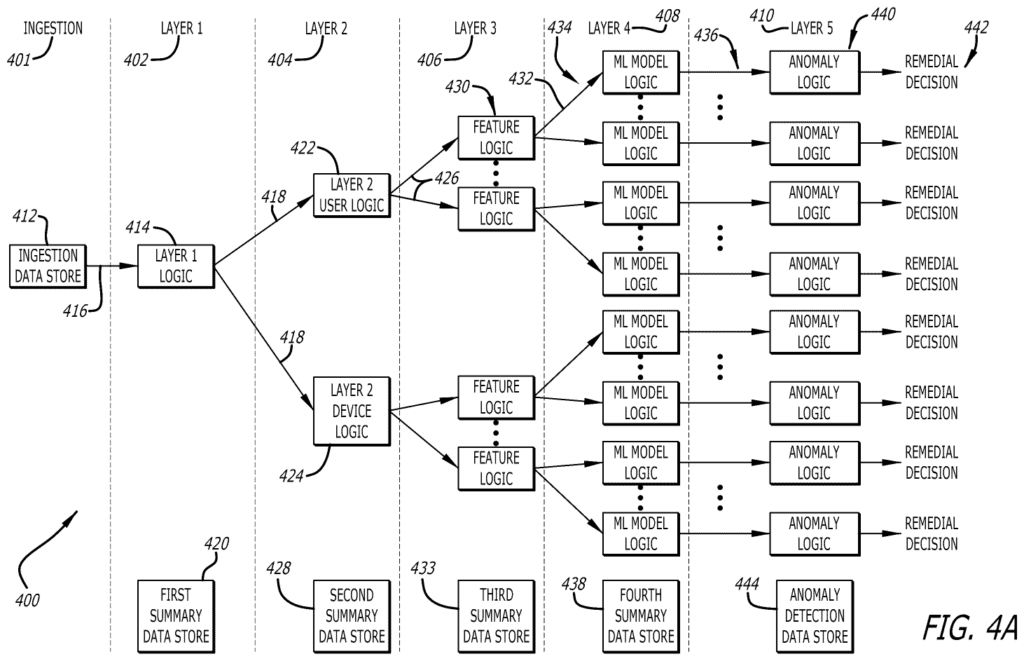

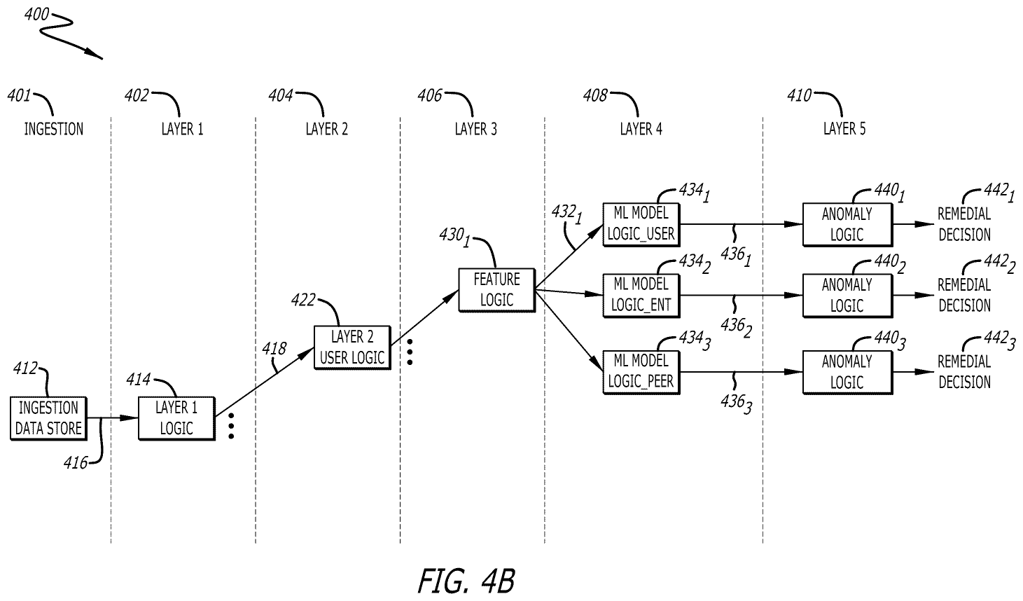

With brief reference to FIG. 4A as an example, the output of Layer 3 406 (resulting from execution of the logic 208) is an entity-level feature vector that is provided to Layer 4 408, which performs anomaly detections. Taking the output of logic 432₁ as a particular example, the output of its processing is a user feature vector 436₁, which serves as input to a plurality of anomaly detections. In this case, the user feature vector 436₁ serves as input to a set of ML models (deployed by the logic modules 442₁-442₃) that are each configured to perform an anomaly detection. A first logic module 442₁ may be configured to utilize the ML model to generate a label for each user by assessing each user's features separately. A second logic module 442₂ may be configured to utilize the ML model to generate a label for each user by assessing each user's features in view of other user's features, such as at an enterprise level. A third logic module 442₃ may be configured to utilize the ML model to generate a label for each user by assessing each user's features in view of other user's features, such as at a peer group level, which represents a subset of the enterprise level. The labels (e.g., scoring result) generated by each anomaly detection is then stored in a summary index such as the fourth summary index 456 (which may be represented by the summary index 214 in FIG. 2).

In some examples, the anomaly detection process may include the use of a machine-learning toolkit (MLTK) that deploys machine learning techniques through execution of query statements, such as those provided in a search processing language. Examples of such queries may include the use of specific search processing language commands such as “fit” (train a machine learning model on given data) and “apply” (deploy the trained machine learning model). The use of MLTK may include deployment of the same machine learning methods discussed previously. In some examples, utilization of an ML model to generate a scoring according to a single user's features, such as that of the logic module 442₁ in FIG. 4A, may be performed through a log likelihood methodology (discussed below). The utilization of ML models to generate scorings according to a single user's features in view of users within an enterprise or in view of users within a peer group, such as that of the logic modules 442₂₋₃ in FIG. 4A, may be performed through MLTK.

The logic 216 is configured to, upon execution by one or more processors, obtain the scoring results generated by the logic 212 and perform remedial action determinations that, for example, may result in the generation of alerts or risk annotations, network communications being transmitted to an administrator such as a SOC analyst, or other practical applications such as blocking network traffic from an IP address associated with an anomalous feature (e.g., the source or recipient of an anomalous amount of network traffic). In some examples, the logic 216 performs threshold comparisons between the scoring results and one or more thresholds. The logic 216 may also tagging events (portions of the ingested data as discussed below) with risk scores or anomaly categories and write the threshold determination results, tags, and risk scores to the detection index 218. Thus, the logic 216 connects the model output from the logic 212 to actionable outcomes and actions. As the output from earlier layers (e.g., logic modules 200, 204, 208, and 212) are aggregated in a manner to serve multiple anomaly detections as illustrated in FIGS. 4A-4B, the multi-layer anomaly detection pipeline architecture of the anomaly detection subsystem 150 enables fine-grained detection customization while keeping core logic reusable and centralized, which ultimately improves the speed at which detections may be made, reduces the amount of processing performed, and decreases the utilization of computing resources all of which directly improve the processing of a computing device while performing anomaly detections relative to current anomaly detection technologies that utilize machine learning.

The remedial action component 220 is configured to, upon execution by one or more processors, obtain results from the logic 216 as to whether detected anomalies satisfy risk score thresholds such that remedial action is to be taken. Example remedial actions may include generating alerts, notifications, graphical user interfaces (GUIs), and/or network communications to alert an administrator such as a SOC analyst to take a specified action (collectively illustrated as, “alerts 222”). In some examples, such may instruct the administrator on a particular action to take such as updating firewall settings or configurations, alerting network users to malicious network communications (email), etc. In other examples, the remedial action component 220 may automatically perform certain remedial actions based on the anomaly or anomalies detected that satisfy certain threshold comparisons. For example, remedial actions for detected anomalies pertaining to excess network traffic in or out of an enterprise network may trigger the remedial action component 220 to block network traffic to/from one or more particular IP addresses sending or receiving the excess network traffic. This may be performed by implementing rules or configurations at a firewall or other network device. As another illustrative example, detected anomalies that indicate certain devices are making an anomalous number of connections (e.g., establishing TCP sessions, connecting to webservers using HTTP over TCP/IP, exchanging information using BGP/OSPF protocols, establishing wireless connections such as BLUETOOTH®, etc.). Collectively, the automated instructions and/or actions are illustrated as “automated instructions/actions 224.” These are merely illustrative examples and not intended to limit the scope of the disclosure.

As noted above, the logic modules 200, 204, 208, 212, and 216 form a multi-layer anomaly detection pipeline. This architecture brings three significant technological improvements and advantages relative to current anomaly detection technologies that utilize machine learning. First, the architecture enables near-real-time updates; if new data arrives, only the latest window needs to be processed (as discussed with respect to the logic 200 forming layer 1). Second, the architecture avoids the need to reprocess the entire history on every run, reducing computational overhead dramatically. This is in direct contrast to current anomaly detections that utilize machine learning where a retrieval of the ingested data and processing of features over the entire time period (e.g., a month) is required for each anomaly detection. This is computationally unscalable as such requires enormous and unreasonable computational resources as the number of entities (users and devices) and/or anomaly detections (ML models deployed) grows. This is true from both a data retrieval perspective and a data processing perspective. The reduction in cardinality by each layer of the architecture is noted above; which is not the case in current anomaly detections using machine learning.

Third, and with respect to particular embodiments that utilize queries, such as those formatted in a search processing language, the architecture may be configured to leverage native searching processing language operators such as collect, appendpipe, and summary indexing (as used in the searching processing language developed by Splunk). As a result, the anomaly detection subsystem can operate fully within standard customer deployments without requiring custom infrastructure.

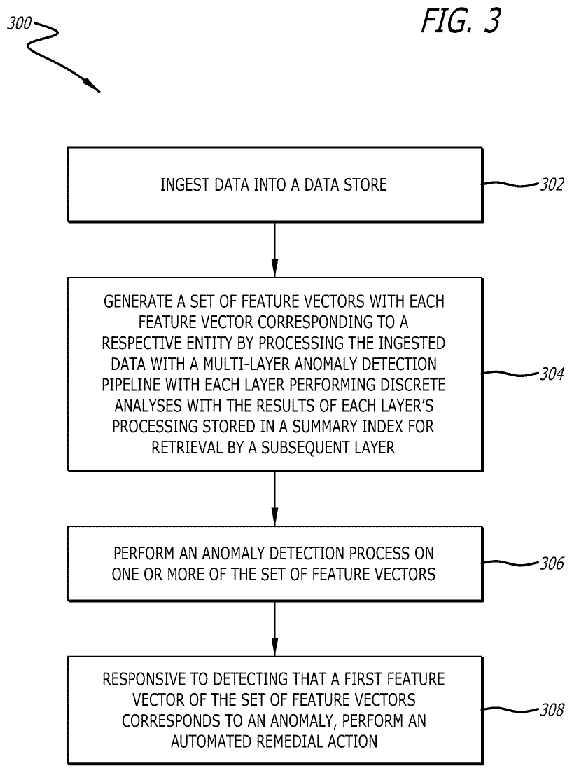

Referring now to FIG. 3, a flow diagram illustrating a high-level embodiment of an anomaly detection process implemented by the anomaly detection subsystem of FIGS. 1 and 2 is shown in accordance with various embodiments of the disclosure. FIG. 3 illustrates an example process 300 of anomaly detection on ingested data using the anomaly detection subsystem of FIGS. 1 and 2. The example process 300 may be implemented, for example, by a computing device that comprises one or more processors and non-transitory computer-readable medium and is specifically configured with the logic modules set forth in FIGS. 1 and 2. The non-transitory computer readable medium may store instructions that, when executed by the processor(s), cause the processor(s) to perform the operations of the illustrated process 300.

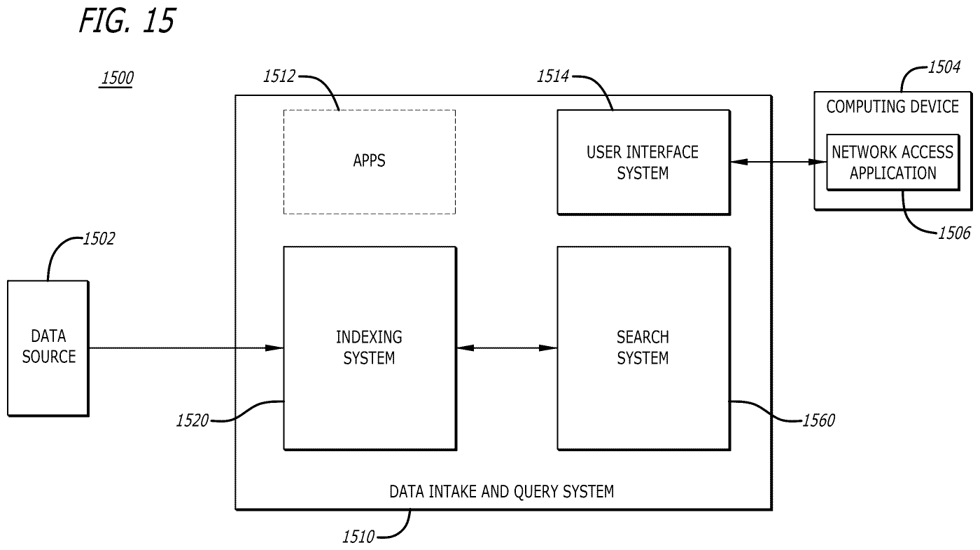

Each block illustrated in FIG. 3 represents an operation of the process 300. It should be understood that not every operation illustrated in FIG. 3 is required. In fact, certain operations may be optional to complete aspects of the process 300. The process 300 begins with an operation of ingesting data into one or more data stores (block 302). One example embodiment of ingestion data into indexes within a data intake and query system is detailed below with respect to at least FIGS. 15-18. However, other examples may include ingestion of data into cloud storage modules such as Amazon Web Services® (AWS) S3 buckets, Microsoft Azure® Blob storage, Google® Cloud Storage (GCS), Oracle Cloud Object Storage®, or cloud block storages such as AWS Elastic Block Storage (EBS), etc.

Following ingestion of the data, a set of feature vectors is generated with each feature vector corresponding to a respective entity by processing the ingested data with a multi-layer anomaly detection pipeline with each layer performing discrete analyses with the results of each layer's processing stored in a summary index for retrieval by a subsequent layer (block 304). Additional detail as to the generation of feature vectors is provided above with respect to FIGS. 1 and 2, where the anomaly detection subsystem 150 is described as including logic modules such as a layer 1 logic 200, a layer 2 logic 204, a layer 3 logic 208, a layer 4 logic 212, a layer 5 logic 216, and a remedial action component 220. The operability of each logic module is described above, and example implementations are described below with respect to at least FIGS. 4-6.

The process 300 subsequently includes performance of an anomaly detection process on a set of one or more of the feature vectors (block 306). The anomaly detection process may be carried out by the layer 4 logic 212 of FIG. 2. Responsive to detecting that a first feature vector of the set of feature vectors corresponds to an anomaly, the process 300 includes performance of an automated remedial action (block 308). The automated remedial action may be carried out by the layer 5 logic 216 of FIG. 2.

### B. Multi-Layer Anomaly Detection Pipeline

Referring now to FIG. 4A, an illustration of an example multi-layer anomaly detection pipeline formed by the components of the anomaly detection subsystem is shown in accordance with various embodiments of the disclosure. FIG. 4A illustrates an example directed acyclic graph (DAG) 400 comprised of a plurality of stages or layers including a first layer 402, a second layer 404, a third layer 406, a fourth layer 408, and a fifth layer 410. Additionally, the illustration of FIG. 4A illustrates an ingestion layer 401 that provides data 416 from an ingestion data store 412 to layer 1 logic 414, which performs operations of pre-processing the data 416 to extract low-resolution features (extracted features 418) that are stored in a first summary data store 420. The data 416 is retrieved from the ingestion data store 412 in predefined time segments, e.g., a first time window. As one example, the first time window refers to a 60 minute time window. The retrieval of a time segment of the data 416 may be retrieved at regular, e.g., hour intervals with results of each processing stored in the first summary data store 420.

The multi-layer anomaly detection pipeline operates in a sequential manner such that as the results of the processing by the layer 1 logic 414, the extracted features 418, are obtained by logic modules of the second layer, i.e., layer 2 user logic 422 and layer 2 device logic 424. The logic modules of the second layer are configured to each perform operations at an entity level where the layer 2 user logic 422 is configured to perform operations on the extracted features 418 by user, and the layer 2 device logic 424 is configured to perform operations on the extracted features 418 by device.

Each of layer 2 user logic 422 and the layer 2 device logic 424 are configured to perform of an aggregation process on the extracted features 418 that are stored in the first summary data store 420 with each logic module generating aggregated features on a per user or per device basis and storing the aggregated features in the second summary data store 428. The aggregation process is performed over a second time window, which, in some examples, is 24 hours, e.g., one day. Thus, in such an example, the logic modules of the second layer aggregate the extracted features 418 over the previous day. Importantly, this aggregation is done on a rolling basis, e.g., as each hour block of ingested data 416 is analyzed by the layer 1 logic 414, the second layer utilizes a sliding window to analyze the previous 24 hours of ingested data 416. Additional detail on the aggregation operations is discussed below.

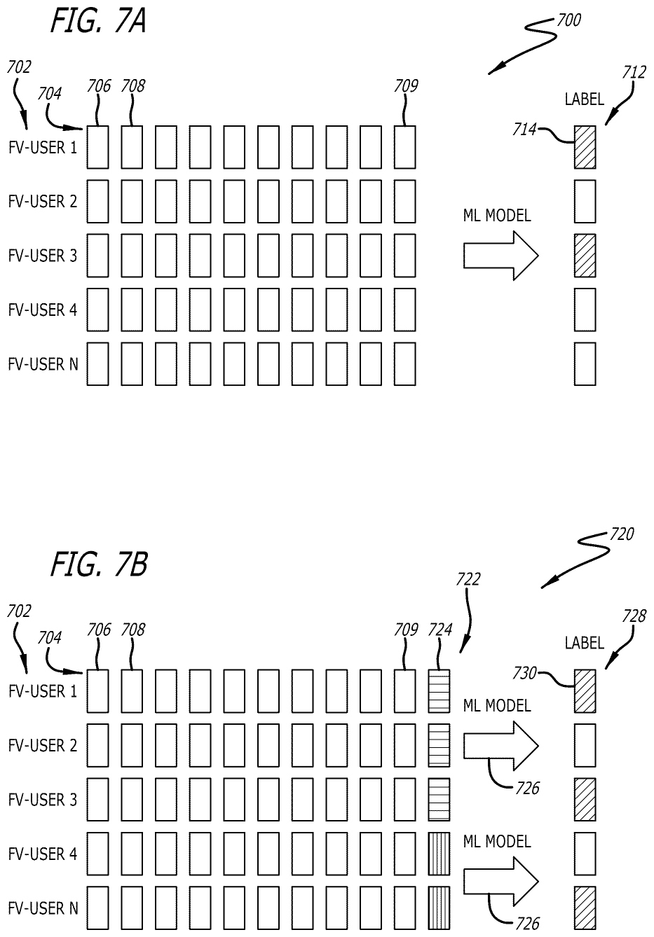

The aggregated features are then stored in the second summary data store 428. For purposes of clarity, processing of only one path through the multi-layer anomaly detection pipeline will be discussed for the third, fourth, and fifth layers will be discussed as other parallel paths provide the same operability. In particular, the aggregated features 426 resulting from the operations of the layer 2 user logic 422 are provided to feature logic 430 of the third layer 406. The feature logic 430 is configured to perform deep feature engineering on the aggregated features 426 over a third time window on a per entity basis (here, a per user basis) resulting in a feature vector comprising one or more features for a single entity (here, user). The generated feature vectors 432 are stored in the third summary data store 433. Additional detail with respect to the feature vectors 432 is provided below with respect to at least FIGS. 4 and 7A-7B.

Following generation of the feature vectors 432 on a per user basis, the ML model logic 434 of the fourth layer 408 performs an anomaly detection process on the feature vectors 432 resulting in detection of one or more anomalies, which includes providing the feature vectors 432 to an ML model that is trained and configured to generate a set of labels 436 (one label for each feature vector of the feature vectors 432, where each feature vector corresponds to a particular user). Each label of the set of labels 436 indicates whether the features represent anomalous behavior or activity by the corresponding user. The set of labels 436 may be stored in the fourth summary data store 438.

Following generation of the set of labels 436, an anomaly logic 440 of the fifth layer 410 performs a remedial action determination process including one or more threshold comparisons with the set of labels 436 and a threshold corresponding to the anomaly detection performed by the ML model of the ML model logic 434 and causing performance of one or more remedial actions as applicable. Additional detail and examples of the remedial action determination and automated remedial actions are provided below.

Importantly, the ingested data 416 is retrieved from the ingestion data store 412 only once, enabling what may be referred to as O(10) detections per read. In some examples, UEBA detections are run daily and rely on 30 days of historical data to identify anomalies within the last 24 hours. A naive approach includes querying the entire 30-day window separately for each detection (e.g., each ML model of the fourth layer 408), which leads to extreme usage of computing resources and, when implemented on a data intake and query system, massive overhead on a search head and indexers. Instead, the multi-layer anomaly detection pipeline of FIG. 4A computes hourly feature aggregates, which are merged over time using a rolling window approach. This results in a 30× reduction in query cost per detection. Combined with O(10) detections per read, the total efficiency gain is on the order of 300×, which enables the scaling of UEBA detections.

Referring now to FIG. 4B, an illustration of portion of the multi-layer anomaly detection pipeline of FIG. 4A is shown in accordance with various embodiments of the disclosure. FIG. 4B illustrates the same five layers of the DAG 400 as shown in FIG. 4A along with the ingestion layer 401 while providing additional detail on an implementation of the fourth layer 408 and the fifth layer 410 with respect to results of the feature logic 430₁ (representative of a first instance of the feature logic 430 of FIG. 4A) obtained by three instances of the ML model logic 434 of FIG. 4A, which include the ML model logic_user 434₁, the ML model logic_ent 434₂, and the ML model logic peer 434₃. In such an embodiment, the feature vector 432₁ generated by the feature logic 430₁ is provided as input to each of the ML model logic_user 434₁, the ML model logic_ent 434₂, and the ML model logic_peer 434₃ with the ML model logic_user 434₁ performing a detection solely on a particular user's history, the ML model logic_ent 434₂ performing a detection based on an entire grouping of user's feature vectors (e.g., includes an aggregation over the group, or “enterprise,” to determine anomalies within the enterprise), and the ML model logic_peer 434₃ performing a detection based on peer grouping. The detections performed by the ML model logic_user 434₁, the ML model logic_ent 434₂, and the ML model logic_peer 434₃ correspond to the same potential anomaly but assess whether a particular user's feature vector represents an anomaly in view of different contexts.

The anomaly logic 440₁, the anomaly logic 440₂, and the anomaly logic 440₃ obtain the results of the detections performed in the fourth later 408 and determine whether any remedial decision should be performed such as the remedial decision 442₁, the remedial decision 442₂, or the remedial decision 442₃. The thresholds may differ for each anomaly logic as the risks may differ depending on whether the detection was based solely on a user's history, an enterprise context, or a peer context.

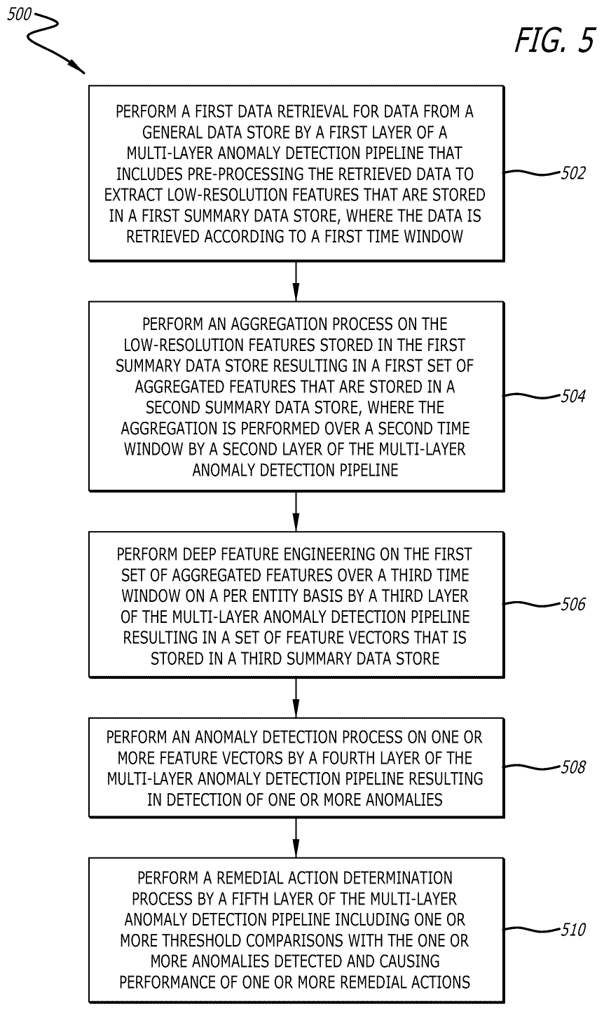

Referring now to FIG. 5, a flow diagram illustrating an embodiment of an anomaly detection process implemented by the anomaly detection subsystem deploying the multi-layer anomaly detection pipeline of FIG. 4 is shown in accordance with various embodiments of the disclosure. FIG. 5 illustrates an example process 500 of anomaly detection on ingested data using the anomaly detection subsystem of FIGS. 1 and 2. The example process 500 may be implemented, for example, by a computing device that comprises one or more processors and non-transitory computer-readable medium and is specifically configured with the logic modules set forth in FIGS. 1 and 2. The non-transitory computer readable medium may store instructions that, when executed by the processor(s), cause the processor(s) to perform the operations of the illustrated process 500.

Each block illustrated in FIG. 5 represents an operation of the process 500. It should be understood that not every operation illustrated in FIG. 5 is required. In fact, certain operations may be optional to complete aspects of the process 500. Prior to the initiation of the process 500, it is assumed that data has been ingested into a storage system, as discussed above. Thus, process 500 begins with an operation of performing a first data retrieval from a general data store by a first layer of a multi-layer anomaly detection pipeline (block 502). Additional operations of the first layer may include pre-processing the retrieved data to extract low-resolution features that are stored in a first summary data store, where the data is retrieved according to a first time window. As one example, the first time window refers to a 60 minute time window. In some instances, the process 500 is run at hour intervals with results of processing the retrieved data stored in summary data stores as discussed below.

Following performance of the first layer operations, the process 500 includes performance of an aggregation process on the low-resolution features stored in the first summary data store resulting in a first set of aggregated features that are stored in a second summary data store (block 504). The aggregation process is performed over a second time window by a second layer of the multi-layer anomaly detection pipeline. In some examples, the second time window is 24 hours, e.g., one day, in which case, the second layer aggregates the features extracted in the first layer over the previous day. As noted above, this aggregation is done on a rolling basis.

Using the aggregated features generated by the second layer operations, logic of a third layer of the anomaly detection subsystem 150 performs deep feature engineering on the first set of aggregated features over a third time window on a per entity basis resulting in a feature vector comprising one or more features for a single entity (block 506). For example, a first feature vector may correspond to a first set of features for a first user, and a second feature vector may correspond to the same first set of features for a second user. As should be understood, the values for the features may differ for each user. Further, a third feature vector may correspond to a second set of features for the first user, and a fourth feature vector may correspond to the same second set of features for the second user. As discussed below, a first anomaly detection (including a first ML model) may receive the first and second feature vectors as input resulting in a generation of a label as to whether either represents an anomaly (e.g., the label may be a risk score assessed later in the pipeline). Similarly, a second anomaly detection (including a second ML model) may receive the third and fourth feature vectors as input resulting in a generation of a label as to whether either represents an anomaly. FIGS. 7A-7B provide illustrative examples.

As noted, following generation of a set of feature vectors on a per entity basis, the anomaly detection subsystem 150 performs an anomaly detection process on one or more feature vectors by a fourth layer of the multi-layer anomaly detection pipeline resulting in detection of one or more anomalies (block 508). The anomaly detection process may include providing one or more feature vectors to an ML model that is trained and configured to generate a label as to whether a feature vector represents an anomaly. The anomaly detection process generates a risk score for each feature vector to which an anomaly detection is performed (e.g., each ML model applied deployed).

Following the anomaly detection process of the fourth layer of the multi-layer anomaly detection pipeline, a fifth layer of the multi-layer anomaly detection pipeline performs a remedial action determination process including one or more threshold comparisons with the one or more labels generated by the anomaly detection process and causing performance of one or more remedial actions as applicable (block 510). As the anomaly detection process may generate risk scores for each feature vector, the fifth layer may compare the risk score of a first feature vector to a threshold pertaining to the anomaly detection applied to the first feature vector and, when the threshold comparison is satisfied (e.g., the risk score meets or exceeds the threshold), a remedial action is initiated. It should be understood that different anomaly detections may have different risk scores. For example, an anomaly detection that considers an individual user's number of connections may have a higher risk score than an anomaly detection that considers an individual user's download volume (e.g., byte of data download).

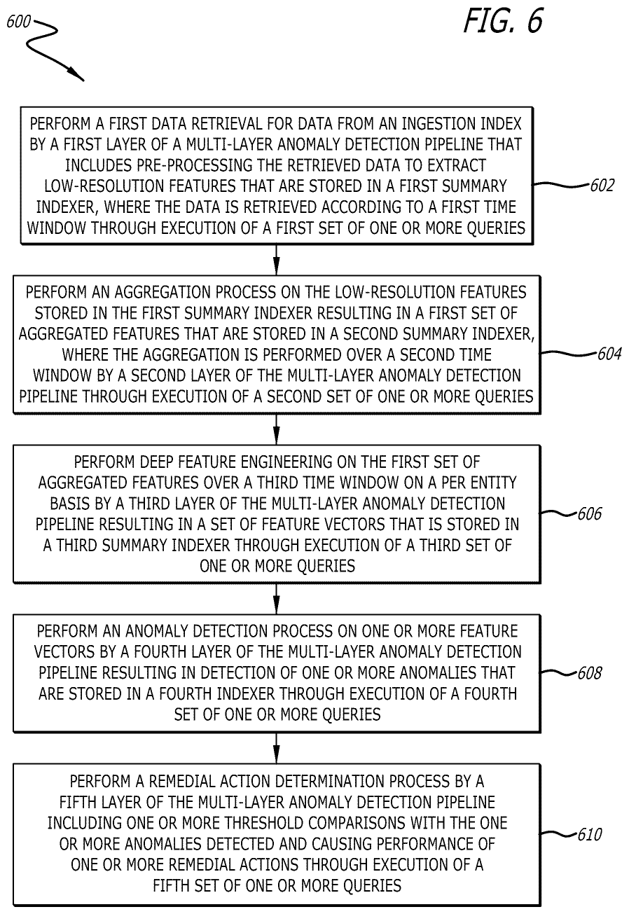

Referring now to FIG. 6, a flow diagram illustrating an example use case of an anomaly detection process implemented by the anomaly detection subsystem deploying the multi-layer anomaly detection pipeline of FIG. 4 is shown in accordance with various embodiments of the disclosure. FIG. 6 illustrates a similar example process 600 of anomaly detection on ingested data using the anomaly detection subsystem of FIGS. 1 and 2 as that shown in FIG. 5; however, FIG. 6 provides additional detail as to a particular implementation where the logic includes execution of queries provided in a search processing language as discussed in detail below. The example process 600 may be implemented, for example, by a computing device that comprises one or more processors and non-transitory computer-readable medium and is specifically configured with the logic modules set forth in FIGS. 1 and 2. The non-transitory computer readable medium may store instructions that, when executed by the processor(s), cause the processor(s) to perform the operations of the illustrated process 600.

Each block illustrated in FIG. 6 represents an operation of the process 600. It should be understood that not every operation illustrated in FIG. 6 is required. In fact, certain operations may be optional to complete aspects of the process 600. Prior to the initiation of the process 600, it is assumed that data has been ingested into a storage system such as an index as discussed below. Thus, process 600 begins with an operation of performing a first data retrieval from a general index by a first layer of a multi-layer anomaly detection pipeline (block 602). Additional operations of the first layer may include pre-processing the retrieved data to extract low-resolution features that are stored in a first summary index, where the data is retrieved and processed according to a first time window through execution of a first set of one or more queries that may be provided in a search processing language. As one example, the first time window refers to a 60 minute time window. In some instances, the process 600 is run at hour intervals with results of processing the retrieved data stored in summary data indexes as discussed below.

Following performance of the first layer operations, the process 600 includes performance of an aggregation process on the low-resolution features stored in the first summary index resulting in a first set of aggregated features that are stored in a second summary index (block 604). The aggregation process is performed over a second time window by a second layer of the multi-layer anomaly detection pipeline through execution of a second set of one or more queries that may be provided in a search processing language. In some examples, the second time window is 24 hours, e.g., one day, in which case, the second layer aggregates the features extracted in the first layer over the previous day. As noted above, this aggregation is done on a rolling basis.

Using the aggregated features generated by the second layer operations, logic of a third layer of the anomaly detection subsystem 150 performs deep feature engineering on the first set of aggregated features over a third time window on a per entity basis resulting in a feature vector comprising one or more features for a single entity through execution of a third set of one or more queries that may be provided in a search processing language (block 606).

Following generation of a set of feature vectors on a per entity basis, the anomaly detection subsystem 150 performs an anomaly detection process on one or more feature vectors by a fourth layer of the multi-layer anomaly detection pipeline resulting in detection of one or more anomalies through execution of a fourth set of one or more queries that may be provided in a search processing language (block 608). The anomaly detection process may include providing one or more feature vectors to an ML model that is trained and configured to generate a label as to whether a feature vector represents an anomaly. The anomaly detection process generates a risk score for each feature vector to which an anomaly detection is performed (e.g., each ML model applied deployed). The risk scores may be stored in a fourth index.

Following the anomaly detection process of the fourth layer of the multi-layer anomaly detection pipeline, a fifth layer of the multi-layer anomaly detection pipeline performs a remedial action determination process including one or more threshold comparisons with the one or more labels generated by the anomaly detection process and causing performance of one or more remedial actions as applicable through execution of a fifth set of one or more queries that may be provided in a search processing language (block 610). As the anomaly detection process may generate risk scores for each feature vector, the fifth layer may compare the risk score of a first feature vector to a threshold pertaining to the anomaly detection applied to the first feature vector and, when the threshold comparison is satisfied (e.g., the risk score meets or exceeds the threshold), a remedial action is initiated. It should be understood that different anomaly detections may have different risk scores. For example, an anomaly detection that considers an individual user's number of connections may have a higher risk score than an anomaly detection that considers an individual user's download volume (e.g., byte of data download).

### C. Illustrative Search Processing Language (SPL) Example

The following provides a detailed example of an anomaly detection process as performed by one implementation of the anomaly detection subsystem 150, where the logic comprising the anomaly detection subsystem 150 is comprised of search queries provided as Search Processing Language (SPL). The detailed example will be discussed with reference to FIG. 2. The detailed example performs into 30 anomaly detections:
Unusual Volume of Blocked Connections per Device
Unusual Volume of Blocked Connections per Device by Company
Unusual Volume of Blocked Connections per Device by peer-group
Unusual Volume of Data Downloaded per Device
Unusual Volume of Data Downloaded per Device by Company
Unusual Volume of Data Downloaded per Device by peer-group
Unusual Volume of Data Downloaded per User
Unusual Volume of Data Downloaded per User by Company
Unusual Volume of Data Downloaded per User by peer-group
Unusual Volume of Data Uploaded per Device
Unusual Volume of Data Uploaded per Device by Company
Unusual Volume of Data Uploaded per Device by peer-group
Unusual Volume of Data Uploaded per User
Unusual Volume of Data Uploaded per User by Company
Unusual Volume of Data Uploaded per User by peer-group
Unusual Volume of Outgoing Connections per Device
Unusual Volume of Outgoing Connections per Device by Company
Unusual Volume of Outgoing Connections per Device by peer-group
Unusual Volume of Data Bytes per Device
Unusual Volume of Data Bytes per Device by Company
Unusual Volume of Data Bytes per Device by peer-group
Unusual Volume of Blocked Connections per User
Unusual Volume of Blocked Connections per User by Company
Unusual Volume of Blocked Connections per User by peer-group
Unusual Volume of Data Downloaded From Internal Server Per User
Unusual Volume of Data Downloaded From Internal Server Per User by Company
Unusual Volume of Data Downloaded From Internal Server Per User by peer-group
Unusual Volume of Data Uploaded to DMZ Devices per User
Unusual Volume of Data Uploaded to DMZ Devices per User by Company
Unusual Volume of Data Uploaded to DMZ Devices per User by peer-group
Unusual Volume of Outgoing Connections per User
Unusual Volume of Outgoing Connections per User by Company
Unusual Volume of Outgoing Connections per User by peer-group

The layer 1 logic 200 is comprised of SPL that is configured to ingest network traffic data, perform pre-processing and normalization operations, and compute high-level features required for downstream analytics. The resulting feature set is stored in a summary index (e.g., the summary index 202) and serves as a foundational layer for the 30 anomaly detections listed above. These features encapsulate the necessary contextual information for the detections to function effectively. In this example, the SPL query runs hourly, processing data from the most recent 1-hour window, enabling efficient, low-latency feature generation without reprocessing historical data. The SPL representing the layer 1 logic 200 may be referred to as “hourly SPL” due to the 1-hour window and one version is provided below:

| ‘unusual_network_traffic_volume_data_map(“*”)’
| eval date=strftime(_time, “%Y-%m-%d”)
| eval dvc_bunit= coalesce(dvc_bunit, “YOUR_BU”)
| eval user_bunit= coalesce(user_bunit, “YOUR_BU”)
| fields date, device, bytes, bytes_in, bytes_out, direction, dvc_bunit, user,
user_bunit, dest_zone, src_zone
| stats count as connections, sum(bytes_in) as bytes_in, sum(bytes_out) as
bytes_out,
sum(bytes) as bytes by device, direction, date, dvc_bunit, dest_zone, src_zone,
user, user_bunit
| collect index=ueba_summaries source=unusual_network_traffic_volume_daily
addtime=true

The hourly SPL above is comprised of three major components, each capturing a distinct aspect of the anomaly detection pipeline: data ingestion, cleaning, and normalization. The macro “unusual_network_traffic_volume_data_map(“*”)” abstracts away the source-specific complexities of the raw data. This macro, upon execution, causes reading of the network traffic data, filtering noise, and aligning fields to a consistent schema. This serves to isolate schema dependencies. As a result, if there are changes to the data source or schema, only the macro needs to be updated, and the rest of the detection pipeline remains untouched.

```
from datamodel:Network_Traffic.All_Traffic
| where action==“blocked” or isnotnull(bytes) or isnotnull(bytes_in) or
isnotnull(bytes_out) or direction==“outbound”
‘‘‘ filter used by contributing events search ’’’
| search $first_filter$
‘‘‘ set direction field ’’’
| eval direction = case(isnotnull(direction), direction,
  (lower(src_zone) like “%outside%”) and (lower(dest_zone) like
“%outside%”), “outbound”,
  (lower(src_zone) like “%inside%”) and (lower(dest_zone) like “%inside%”),
“inbound”,
  (lower(src_zone) like “%inside%”), “outbound”,
  (lower(src_zone) like “%outside%”), “inbound”,
  (lower(dest_zone) like “%inside%”), “inbound”,
  (lower(dest_zone) like “%outside%”), “outbound”,
  bytes_in > bytes_out, “inbound”,
  bytes_in < bytes_out, “outbound”,
  isnotnull(bytes_in) and isnull(bytes_out), “inbound”,
  isnotnull(bytes_out) and isnull(bytes_in), “outbound”,
  true( ), null( ))
‘‘‘ only process traffic with direction ’’’
| where isnotnull(direction)
‘‘‘ set bytes_in, bytes_out, bytes field ’’’
| eval bytes_in = case(isnotnull(bytes_in), bytes_in, direction==“inbound”, bytes,
true( ), bytes_in)
| eval bytes_out = case(isnotnull(bytes_out), bytes_out, direction==“outbound”,
bytes, true( ), bytes_out)
| eval bytes = case(isnotnull(bytes), bytes, isnotnull(bytes_in) and
isnotnull(bytes_out), bytes_in + bytes_out, isnotnull(bytes_in), bytes_in, true( ),
bytes_out)
‘‘‘ normalize dest_zone, src_zone, device, direction fields ‘‘‘
| eval dest_zone = case(lower(dest_zone)==“inside”, “inside”,
lower(dest_zone)==“outside”, “outside”, lower(dest_zone) like “%dmz%”,
“dmz”, true( ), “others”)
| eval src_zone = case(lower(src_zone)==“inside”, “inside”,
lower(src_zone)==“outside”, “outside”, lower(src_zone) like “%dmz%”, “dmz”,
true( ), “others”)
| eval device = case(direction==“inbound”, dest, direction==“outbound”, src,
true( ), “UNKNOWN_DEVICE”)
| eval direction = case((action==“blocked”) AND (direction==“outbound”),
“blocked_outbound”, (action==“blocked”) AND (direction==“inbound”),
“blocked_inbound”, true( ), direction)
‘‘‘ set action field ’’’
| eval action = case(action==“blocked”, “blocked”, true( ), “allowed”)
```

The first layer includes feature generation, which includes operations of computing low level aggregates on an hourly basis using SPL that recites: ‘| stats count as connections, sum(bytes_in) as bytes_in, sum(bytes_out) as bytes_out, sum(bytes) as bytes by device, direction, date, dvc_bunit, dest_zone, src_zone, user, user_bunit’. The features are computed using the “stats” command and are then aggregated over a large set of keys: ‘device, direction, date, dvc_bunit, dest_zone, src_zone, user, user_bunit’. Grouping over a large set of keys allows downstream detections to extract necessary information from these low level aggregates. Finally, the features (results) are written in a feature store using a summary index using SPL that recites:

‘collect index = ueba_summariessource=unusual_network_traffic_volume_daily
addtime=true.’

Referring now to the second layer, the layer 2 logic 204 is comprised of SPL that is configured to be is executed daily and reads hourly aggregates from index=ueba_summaries with source=unusual_network_traffic_volume_daily for the past 24 hours. The SPL representing the layer 2 logic 204 may be referred to as “daily SPL” due to the 24-hour window. At this layer, the anomaly detection pipeline is fully decoupled from the raw data and the original network traffic data. This architectural choice drastically reduces data volume. In some instances, raw ingestion may be approximately 1 TB/day, the derived feature store consumes only approximately 100 MB/day. Within this daily SPL, daily aggregates are computed on a per-device and per-user basis (entity-level). As a result, two separate SPLs are maintained, one for users and one for devices, although all other keys and logic remain consistent. The user X device space (users multiplied by devices) is a high-cardinality set, especially over a 24-hour period, and separating the two helps improve query performance and storage efficiency (move toward optimization). At the end of the daily SPL, the computed features are written to two distinct summary indexes:

For per-user features: index=ueba_summaries and
source=unusual_network_traffic_volume_per_user_30days
For per-device features: index=ueba_summaries and
source=unusual_network_traffic_volume_per_device_30days

An example daily SPL for generating per-user features is provided below:

index=ueba_summaries source=unusual_network_traffic_volume_daily
user!=“unknown”
| stats sum(connections) as connections, sum(bytes_in) as bytes_in,
sum(bytes_out) as bytes_out, sum(bytes) as bytes by user, direction, dest_zone,
src_zone, date,user_bunit
| collect index=ueba summaries
source=unusual_network_traffic_volume_per_user_30days

Referring now to the third layer, the layer 3 logic 208 is comprised of SPL that is configured to execute on the features written to a summary index in the second layer, unusual_network_traffic_volume_per_user_30 days. It may be observed that low-level features are aggregated over several keys: user, direction, dest_zone, src_zone, date, and user_bunit. Each anomaly detection consumes a strict subset of these dimensions, depending on the nature of the anomaly being modeled. For instance, a data upload anomaly focuses only on records where direction=outbound while a download anomaly from DMZ servers filters for src_zone=DMZ and direction=inbound.

The primary role of the SPL executed during the third layer (which may be referred to as “feature SPL”) is to (i) narrow down the feature space to only what is relevant for the specific detection, and (ii) discard unrelated combinations of keys and values to reduce noise and improve modeling efficiency.

Subsequent to the filtering, feature vector computation may be performed. For user-based anomaly detections, a feature vector per user is generated, which encodes aggregated user behavior over the past 30 days, and contextual activity in the most recent day. This results in one row per user and is configured to be consumed by a downstream machine learning model. These features vectors are written to a dedicated feature store:

index=ueba_summaries
source=unusual_network_traffic_dmz_server_per_user_feature_upload

A sample feature SPL for feature vector construction is provided below:

```
index=ueba_summaries
source=unusual_network_traffic_volume_per_user_30days direction=outbound
dest_zone=“dmz” bytes_out>0
| stats sum(connections) as connections, sum(bytes_out) as bytes by user,
user_bunit, date
| ‘get_day_before_latest_time(“scan_date”)‘
| eval day_ago = floor((scan_date − strptime(date, “%Y-%m-%d”)) / 86400)+1
| eval historical = if ( day_ago < 2, 0, 1)
| stats sum(historical) as historical_count, mean(bytes) as mean_bytes,
stdev(bytes) as stdev_bytes by user,user_bunit, historical
| eval historical_mean_bytes = if(historical == 1, mean_bytes, 0)
| eval historical_stdev_bytes = if(historical == 1, stdev_bytes, 0)
| eval present_bytes = if(historical == 0, mean_bytes, 0)
| stats sum(historical_count) as historical_count, max(historical_mean_bytes) as
historical_mean_bytes,
  max(historical_stdev_bytes) as historical_stdev_bytes,
  max(present_bytes) as present_bytes by user, user_bunit
| ‘get_day_before_latest_time(“_time”)‘
| collect index=ueba_summaries
source=unusual_network_traffic_dmz_server_per_user_feature_upload
addtime=true
```

Following generation of the entity-level feature vectors, the logic of the fourth layer obtains the entity-level feature vectors and performs anomaly detection operations that result in a label, e.g., a probabilistic label, for each feature vector indicating whether the feature vector represents an anomaly, or the probability that the feature vector represents an anomaly as discussed above. The anomaly detection operations include utilization of one or more machine learning models that are configured to take the feature vectors as input as generate a label for each. The logic of the fourth layer, e.g., the layer 4 logic 212, is comprised of SPL and may be referred to as “ML model SPL.”

In some examples, detection-specific filtering logic is included “early” in the SPL, e.g., toward the beginning of the pipeline query and is done to improve efficiency of the SPL. For example, if a user's historical upload volume consistently exceeds their activity in the last 24 hours, we may deterministically mark the user as benign without invoking a machine learning model. Such logic is more efficiently captured through rules-based filtering rather than statistical modeling. This hybrid approach-combining rules for clear-cut cases and ML for ambiguous scenarios-ensures faster processing and reduced load on the anomaly detection subsystem 150 and the computing resources on which it is processing. In addition to the core detection logic, the ML model SPL may also capture a rich set of metrics such as baselines, activity, anomaly, etc., which are logged for observability and explainability for analysts. All such metadata may be stored in summary indexes:

index=ueba_summaries
source=unusual_network_traffic_dmz_server_per_user_log_upload

This logging infrastructure ensures full transparency, auditability, and accountability of detection outcomes. The following provides an example of ML model SPL:

index=ueba_summaries
source=unusual_network_traffic_dmz_server_per_user_feature_upload
| eval filter_condition = if ((present_bytes > 3*historical_mean_bytes) and
(historical_mean_bytes > 0) and (historical_stdev_bytes > 0), 1, 0)
| eventstats p25(present_bytes) as perc_threshold by filter_condition
| eval filter_condition = if ((filter_condition > 0) and (present_bytes >=
perc_threshold), 1, 0)
| eval zscore = case(historical_stdev_bytes==0, 0.0, filter_condition==0, 0.0,
true( ), abs(present_bytes-historical_mean_bytes)/historical_stdev_bytes)
| eval zscore = round(zscore,1)
| fit DensityFunction zscore lower_threshold=0.000000001
upper_threshold=0.001 dist=“norm” by filter_condition
| eval outlier2 = case (filter_condition==0, 0, ‘IsOutlier(zscore)’ > 0.5, 1, true( ), 0)
| eventstats max(zscore) as max_zscore
| eval p_zscore=case(max_zscore==0, 0, true( ), zscore / max_zscore *100.0)
| rename p_zscore AS unusual_data_upload_to_dmz_per_user_by_company
| eval p_baseline=case(max_zscore==0,0, true( ),
tonumber(mvindex(split(mvindex(BoundaryRanges, 1), “:”), 0)) /
max_zscore*100.0)
| rename p_baseline AS threshold
| eval outlier2 = case (filter_condition==0, 0, ‘IsOutlier(zscore)’ > 0.5, 1, true( ), 0)
| eventstats max(zscore) as max_zscore
| eval p_zscore=case(max_zscore==0, 0, true( ), zscore / max_zscore *100.0)
| rename p_zscore AS unusual_data_upload_to_dmz_per_user_by_company
| eval p_baseline=case(max_zscore==0,0, true( ),
tonumber(mvindex(split(mvindex(BoundaryRanges, 1), “:”), 0)) /
max_zscore*100.0)
| rename p_baseline AS threshold
| collect index=ueba_summaries
source=unusual_network_traffic_dmz_server_per_user_log_upload

Following generation of a label for entity-level feature vector by the ML model SPL in the fourth layer, the logic of the fifth layer obtains each label and performs a determination as to whether the label indicates an action is to be taken or performed. For example, from a log summary index (ueba summaries in the above ML model SPL example or “summary index 214” in FIG. 2), the entities that exhibit high anomaly scores based on their corresponding feature vector are extracted or flagged. The fifth layer serves as the final filtering and decision point in the anomaly detection pipeline and is configured to identify the most relevant and high-confidence anomalies. Upon identification, the logic of the fifth layer, e.g., layer 5 logic 216, may be referred to as “anomaly SPL.”

In some examples, the anomaly SPL is configured to extract critical artifacts—such as user identifiers, contributing assets, scores, and contributing search—that are necessary for escalation or enrichment. In some instances, automated remedial actions may be performed, caused, or initiated by the anomaly detection subsystem 150 as described above. In some examples, the high-risk user or devices entities (feature vectors and/or extracted artifacts) are then correlated with results from other detection systems, from which correlation an overall risk score for the user or entity may be generated or modified. Automated remedial actions may be performed, caused, or initiated as a result of the overall risk score for the user or entity, e.g., automated remedial actions that may not have been performed based solely on the results of the anomaly detection subsystem 150. As a result, the anomaly detection subsystem 150 may serve as a standalone anomaly detection platform and may also integrate into a larger security platform with results among the various subsystems correlated with one another to generate risk scores and/or determine which remedial action(s) are to be performed. The following provides an example anomaly SPL:

index=ueba_summaries
source=unusual_network_traffic_dmz_server_per_user_log_upload
| where outlier2 > 0.5
| eval source_log_category = “Network Traffic CIM”
| eval related_identity_artifacts = user
| lookup unusual_network_traffic_volume_user_device_map user as user output
device as related_asset_artifacts
| eval contributing_events_search = “|
‘unusual_network_traffic_volume_data_map(\”user=\”“ . user . “\”\”)’
| where direction == \”outbound\” AND bytes_out>0 AND dest_zone==\”dmz\”“
| ‘get_earliest_latest_utc(info_min_time, info_max_time)’
| eval ueba_contributing_events_search = contributing_events_search
|
‘unusual_volume_of_data_uploaded_to_dmz_devices_per_user_by_company_filt
er’
D. Example Embodiments and Use Cases

FIGS. 7A-7B provide illustrative examples of the generation of labels indicating whether each of a set of entity-level feature vectors represent an anomaly. The set of entity-level feature vectors may represent the output of a third layer in the multi-layer anomaly detection pipeline discussed here and illustrated as the layer 3 logic 208 of FIG. 2 and the layer 3 406 of FIG. 4A. FIG. 7A provides an example of a set of user-level feature vectors provided as input to a machine learning model, which may be correspond to a first feature vector of the feature vectors 432 provided as input to a first ML model logic of the ML model logic modules 442, where the labels 712 illustrated in FIG. 7A represent the output of one of the ML model logic modules 442. FIG. 7B provides an example of the set of user-level feature vectors divided into two groups (peer groups) with each peer group provided as input to a machine learning model, such as the ML model logic_peer 4363 of FIG. 4B, which may be configured to receive a set of user-level feature vectors, where each feature vector has been assigned a peer group indicator as discussed above.

Referring now to FIG. 7A, a block diagram illustrating a set of user-level feature vectors being provided to machine learning model for label generation within an anomaly detection process is shown in accordance with various embodiments of the disclosure. FIG. 7A provides an illustrative example 700 of a set of feature vectors (set 702) that, as described above, is comprised of a plurality of entity-level feature vectors with FIG. 7A showing an example of user-level feature vectors. The set 702 includes a plurality of feature vectors including the feature vector 704 that corresponds to a first user and is comprised of a set of features including a first feature 706, a second feature 708 and a plurality of other features including a final feature 709. FIG. 7A illustrates the set 702 being provided as input to an ML model for scoring resulting in the labels 712, where, for example, the label 714 corresponds to a label indicating whether the feature vector 704 is representative of an anomaly.

Referring now to FIG. 7B, a block diagram illustrating the set of user-level feature vectors shown in FIG. 7A with a peer group identifier being provided to machine learning model for label generation within an anomaly detection process is shown in accordance with various embodiments of the disclosure. FIG. 7B provides an illustrative example 720 of the set of feature vectors (set 702) from FIG. 7A having been split into peer groups with an indication as to which peer group the feature vector has been assigned added to the feature vector. The indicators 722 represent the peer group indication with indicator 724 illustrating the peer group indicator for the feature vector 704. In contrast to FIG. 7A, which illustrates the set 702 being provided as input to an ML model for scoring resulting in the labels 712, FIG. 7B illustrates each peer group being provided separately as input to the ML model 726. As a result, the ML model 726 considers the features of each feature vector within a peer grouping in determining whether a feature vector represents an anomaly. As seen when comparing the labels 712 in FIG. 7A with the labels 728 in FIG. 7B, the label of “FV-user N” in FIG. 7B is different than that of FIG. 7A due to the peer grouping considerations included in the example of FIG. 7B.

It should be understood that peer-grouping is a powerful technique in behavioral analytics by considering a user's behavior to that of a relevant group, such as department, geo-location, or job title. Analyses that consider peer-grouping help surface deviations that may be statistically normal in a global sense but anomalous within a local peer context.

In many current implementations of anomaly detection that involve peer-grouping, implementing peer-grouping at scale presents serious computational challenges. With tens of thousands of users and hundreds of peer groups, naive implementations require massive fan-out in terms of searches and model evaluations. However, the concepts of the disclose address the inefficiencies and unscalable nature of current implementations of peer-grouping by building peer-group on top of the hierarchical feature store illustrated in and described with respect to at least FIGS. 2A and 4A-4B. In some embodiments of the disclosure, precomputed features are retrieved for each peer group from a summary index, the features within the peer-group are aggregated (e.g., using avg( ), stdev( ) or percentile functions), and labels (probabilistic labels) are generated using a machine learning model to evaluate whether a particular user's feature vectors (representing behavior) is an outlier in its cohort. As the same base features are used across users and groups, the computation is parallelizable and avoids redundant reads. This makes real-time, per-peer-group anomaly detection feasible even in environments with large user populations and frequent group membership changes. In some examples, the peer-grouping process described above is implemented in a search processing language, which keeps the implementation portable and deployable on cloud computing resources.

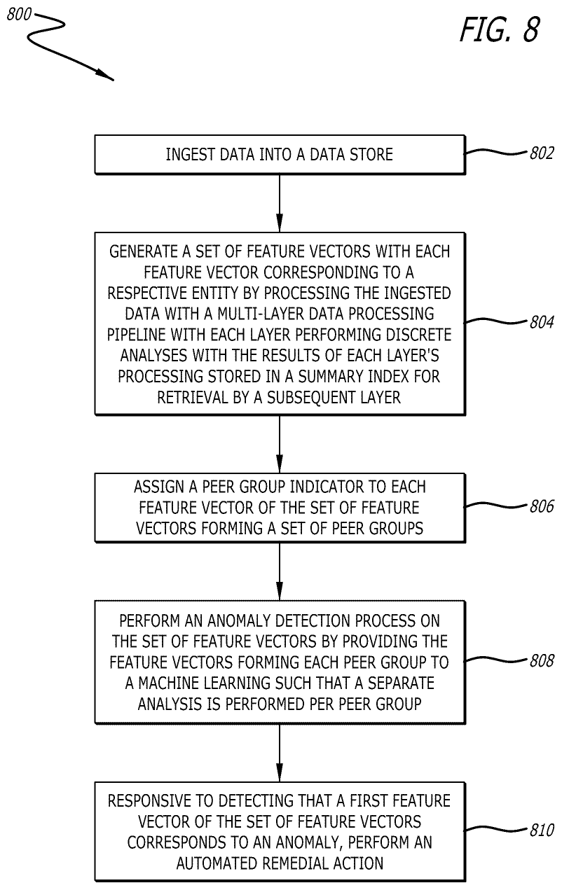

Referring to FIG. 8, a flow diagram illustrating a portion of an embodiment of an anomaly detection process implemented by the anomaly detection subsystem including generating labels for a set of peer-grouped user-level feature vectors through the deployment of machine learning models is shown in accordance with various embodiments of the disclosure. FIG. 8 illustrates an example process 800 of anomaly detection on ingested data using the anomaly detection subsystem of FIGS. 1 and 2. The example process 800 may be implemented, for example, by a computing device that comprises one or more processors and non-transitory computer-readable medium and is specifically configured with the logic modules set forth in FIGS. 1 and 2. The non-transitory computer readable medium may store instructions that, when executed by the processor(s), cause the processor(s) to perform the operations of the illustrated process 800.

Each block illustrated in FIG. 8 represents an operation of the process 800. It should be understood that not every operation illustrated in FIG. 8 is required. In fact, certain operations may be optional to complete aspects of the process 800. The process 800 begins with an operation of ingesting data into one or more data stores (block 802). One example embodiment of ingestion data into indexes within a data intake and query system is detailed below with respect to at least FIGS. 15-18. However, other examples may include ingestion of data into cloud storage modules such as Amazon Web Services® (AWS) S3 buckets, Microsoft Azure® Blob storage, Google® Cloud Storage (GCS), Oracle Cloud Object Storage®, or cloud block storages such as AWS Elastic Block Storage (EBS), etc.

Following ingestion of the data, a set of feature vectors is generated with each feature vector corresponding to a respective entity by processing the ingested data with a multi-layer anomaly detection pipeline with each layer performing discrete analyses with the results of each layer's processing stored in a summary index for retrieval by a subsequent layer (block 804). Additional detail as to the generation of feature vectors is provided throughout the disclosure with various example implementations illustrated in the accompanying drawings. A peer group indicator may be assigned to each feature vector of the set of feature vectors (block 806). As a result, the feature vectors may be separated into peer groups as discussed above with respect to at least FIGS. 7A-7B.

The process 800 subsequently includes performance of an anomaly detection process on the set of feature vectors by providing the feature vectors forming each peer group to a machine learning such that a separate analysis is performed per peer group (block 808). The anomaly detection process may be carried out by the layer 4 logic 212 of FIG. 2. Responsive to detecting that a first feature vector of the set of feature vectors corresponds to an anomaly, the process 800 includes performance of an automated remedial action (block 810). The automated remedial action may be carried out by the layer 5 logic 216 of FIG. 2.

### E. Distributed Machine Learning in Anomaly Detection

User and Entity Behavior Analytics (UEBA) plays a critical role in modern threat detection by identifying deviations from normal behavioral baselines. In some examples, UEBA detections compute baseline behaviors based on the last 30 days of data and then utilize machine learning models to identify any deviations the data. Naturally, these behavioral machine learning models are very resource intensive. For example, if a customer is ingesting 3 TB/day, then a detection is using 90 TB of data to produce anomalies.

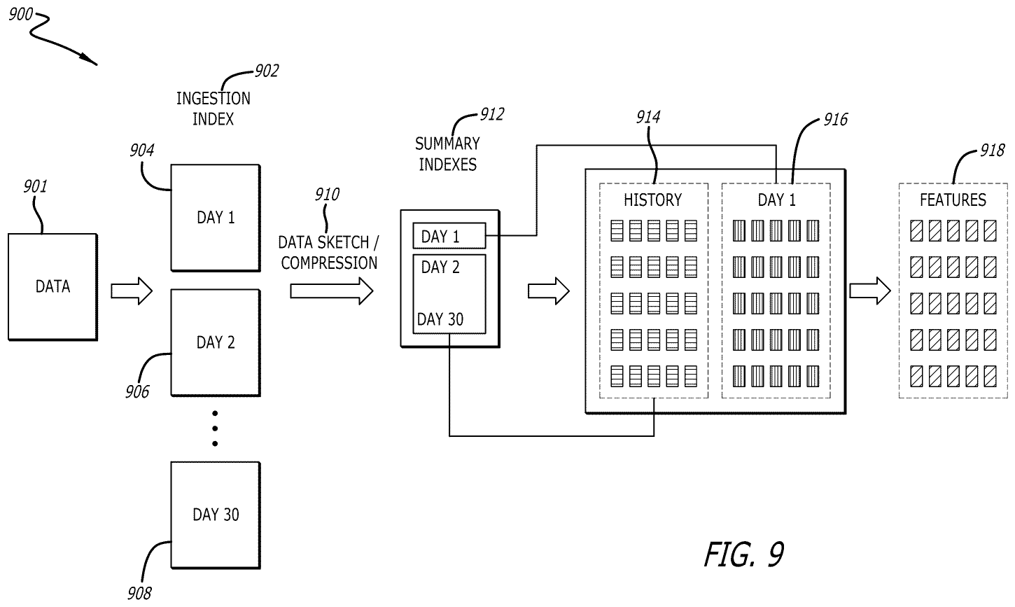

In some current deployments that operate on a data intake and query system, UEBA solutions may operate on a search head as discussed below and the computations are not distributed to indexers. Therefore, it has not been possible to run more than a handful machine learning based behavioral detections directly without running into issues such as skipped searches. The following describes a methodology on features of scalable behavioral detections utilizing a data intake and query system, e.g., with respect to FIG. 9. Following the discussion of FIG. 9, the behavioral anomaly detection problem is formulated as a probability computation, which is then followed by a discussion of a machine algorithm that may be utilized to compute this probability.

Referring now to FIG. 9, an illustration of an implementation of concepts performed by the anomaly detection subsystem of FIGS. 1 and 2 is shown according to various embodiments of the disclosure. FIG. 9 illustrates a machine learning pipeline that includes the ingestion of data for a plurality of entities from one or more data sources with the data being ingested into a first data store, e.g., an ingestion index. In the example illustrated, the data is separated by day within the ingestion index 902, which is illustrated as Day 1 904, Day 2 906, and Day 30 908. Thus, as the raw time-series data 901 is ingested for a plurality of entities, that data 901 is stored in the ingestion index 902. In some examples, the data 901 may be ingested at regular intervals such as every minute, every 5 minutes, every hour, etc. In some instances, the ingested data 901 is a result of the execution of a pipelined search query, such a SPL query as discussed below.

Upon receipt of the ingested data 901, an anomaly detection subsystem 150 may perform data sketch and/or compression operations 910 on the data resulting in a reduced dataset that includes a summary of the raw, ingested data. A data sketch operation may refer to extracting or computing features and aggregating such over rolling time intervals where the features are stored in a probabilistic data structure that summarizes a large dataset in a compact form. Examples of sketch data structures include HyperLogLog (HLL), count-min sketch (approximates the frequency of elements in a dataset, bloom filter (checks whether an element is possibly in a set (membership query)), quantile sketches (e.g., t-Digest) (estimate medians or percentiles), etc. Data sketches are understood to trade accuracy for space (e.g., ˜2% error rate in exchange for a 1000× reduction in memory). Data compression operations reduce the size of the raw ingested data 901 by using encoding schemes that eliminate redundancy while allowing for reconstruction of the original data (lossless) or approximation (lossy).

The reduced dataset is then stored in a second data store (e.g., one or more summary indexes 912). In some instances, as each batch of data 901 is ingested into the ingestion index 902, the data sketch/compression operations 910 are performed thereon to create a reduced dataset with a summary thereof for storage in a one or more summary indexes 912. Some specific examples of the data sketch/compression operations 910 include various statistical computations such as max, mean, standard deviation, sum, etc. As illustrated in FIG. 9, in some instances, both the raw data 901 ingested into the ingestion index 902 and the reduced datasets stored in the one or more summary indexes 912 may be stored according to a timestamp such that a day of generation or day of receipt by a data intake and query system 102 (which includes the anomaly detection subsystem 150) is indicated.

Following the storage of a plurality of reduced datasets and summaries within the one or more summary indexes 912, the anomaly detection subsystem 150 performs transformations and/or vectorization procedures (“vectorization procedure”) on a plurality of the reduced datasets and summaries, namely those within a predetermined historical time period, e.g., 30 days. The vectorization procedure transforms the reduced datasets and summaries into two sets of vectors. A first set represents the data points for a historical time period (“historical vector set 914”), e.g., days 2-30 in the last 30 days, where day 30 is the most historical day. A second vector set represents the data points for a present time period (“present vector set 916”), e.g., day 1 of the last 30 days, where day 1 is the most recent day. As shown in FIG. 9, the historical vector set 914 is comprised of a set of rows, with each row corresponding to data points associated with or generated by a particular entity (user or device), e.g., in the form of a feature vector. Similarly, the rows of the present vector set 916 correspond to the data points associated with or generated by the same entity (e.g., row 1 of each vector set may correspond to a feature vector for a first user while row 2 of each vector set may correspond to a feature vector for a second user).

The anomaly detection subsystem 150 then deploys a machine model that is trained and configured to take the historical and present vector sets as input and determine a score for each row of the present vector set (resultant vector set 918) being the probability that the corresponding row the present vector set 916 represents anomalous behavior or activity in view of the corresponding row in the historical vector set 914. In some embodiments, the results of the machine learning model are then displayed to a user, such as a Security Operations Center (SOC) analyst or another automated remedial action is performed in the same manner as discussed above.

The following discusses particular implementations and also provide discussion on how concepts disclosed throughout the disclosure facilitate formulation of the behavioral anomaly detection problem as a probability determination. As discussed above, one anomaly detection implementation includes computing the divergence between two feature vector set: (1) X (Recent Behavior): e.g., user's activity in the last day; and (2) Y (Historical Baseline): e.g., same user's behavior over the past 30 days.

One method of anomaly detection includes evaluating whether X is likely to be drawn from the same behavioral distribution as Y. A statistically significant divergence implies anomalous behavior. If the probability falls below a certain threshold, the behavior is flagged as anomalous. This approach avoids static thresholds that fail to account for individual differences in behavior across users, departments, or roles. X and Y could be 1-dimensional or multi-dimensional vectors depending on the use case. For example, if a detection is on “unusual volume of upload,” the distribution then clearly we compare distribution of “upload” for 30 days of history is computed and a determination is made as to whether the “upload” from the last 24 hours came from the last 30 days or not. As a second example, if the detection is “unusual data transmission,” then other features are considered as well such as number of connections, transmissions to a new destination, etc. In this case, the vector is of length greater than 1 capturing details about each feature.

This probabilistic framing allows an anomaly detection subsystem to adapt to diverse behavioral baselines. For instance, if an administrator routinely logs in from international locations, their model will adapt to that pattern, whereas the same activity would be anomalous for a human resources (HR) staff member that only logs in from a singular, domestic location. By treating anomaly detection as a hypothesis test, “Is recent behavior drawn from historical distribution?”, the system naturally adjusts to user-specific context, making the detections both precise and interpretable.

With more specificity with respect to deployment with a data intake and query system, machine learning operations have previously operated in the search head of a data intake and query system, which creates bottlenecks when applied to high-volume environments. To address this technical hurdle, the following algorithm is presented as a lightweight, closed-form algorithm that may be provided in a searching processing language and shifts machine learning computation to the indexer layer. This shifts allows the anomaly detection to scale horizontally with the number of indexers and to maintain low-latency detection even under high ingestion volumes.

The algorithm compares two feature vectors, recent behavior (X) and long-term history (Y) using log-likelihood to compute the likelihood of X being drawn from Y. Specific details as to the log-likelihood are provided below. In the case of a univariate vector X, the likelihood becomes a probability. Note that distribution Y need not to be univariate as Y captures historical distribution parameters. In the case of a univariate vector X and assuming Y is following normal distribution, then Y will have two parameters, e.g., mean and standard deviation, which may be an assumption for each feature. Therefore, if the length of X is k, then length of Y is 2*k.

The likelihood computation has a closed form implementation and may be computed at indexer tier and later merged at a search head. The computations may be expressed in a search processing language using, e.g., “streamstats,” “eventstats,” and macros, which enable full transparency and auditability. The distributed execution model ensures that as customer data volume grows, performance scales linearly without placing undue burden on search heads.

The following provides further detail as to the implementation of concepts disclosed herein that incorporate a distributed likelihood algorithm for anomaly detection. In fact, the following discloses a novel distributed algorithm for behavioral anomaly detection, using a log-likelihood-based statistical framework. In some examples, the following may be implemented entirely in a search processing language and executed at the indexer tier of a data intake and query system. The following approach is based on multivariate normality assumptions and transforms the anomaly detection problem into a tractable and efficient vector comparison.

In formulating the anomaly detection problem, let X denote the historical behavior vector of an entity (user or device), and Y denote the present-day behavior vector. The goal is to compute the probability that Y was drawn from the same distribution as X. This is effectively a goodness-of-fit problem. Assuming feature-wise independence and Gaussian-distributed behaviors, each feature is standardized in Y using the mean and standard deviation from X and the corresponding log-likelihood is computed.

The following provides the mathematical foundation beginning with an explanation of how the Z-score is computed. For each feature i∈{1, . . . , n}, we compute the z-score:

$${z}_{i} = \frac{{y}_{i} - {μ}_{i}}{{σ}_{i}}$$

where μi and σi are the mean and standard deviation of the i-th feature from historical vector X, and yᵢ is the corresponding feature in Y.

Next, the probability density function of multivariate normal is discussed. The probability density function (PDF) for a multivariate normal distribution is:

$$f ( X ) = \frac{1}{{( 2 π )}^{n / 2} {\vert \sum \vert}^{1 / 2}} exp ( - \frac{1}{2} {( X - μ )}^{T} {\sum }^{- 1} ( X - μ ) ) \qquad Equation ( 1 )$$

where: X is an n-dimensional observation vector, μ is the mean vector, Σ is the covariance matrix, |Σ| is the determinant of Σ, and Σ⁻¹ is the inverse of Σ.

Additionally, the above is simplified by assuming a standard multivariate normal distribution:

$$μ = 0 , \sum = I$$

Substituting into the PDF:

$$f ( Z ) = \frac{1}{{( 2 π )}^{n / 2} {\vert I \vert}^{1 / 2}} exp ( - \frac{1}{2} {Z}^{T} {I}^{- 1} Z ) \qquad Equation ( 2 )$$

$$= \frac{1}{{( 2 π )}^{n / 2}} exp ( - \frac{1}{2} {Z}^{T} Z ) \qquad Equation ( 3 )$$

because |I|=1 and I⁻¹=I.

To compute the log-likelihood, the logarithm of the PDF is computed:

$$log f ( Z ) = log ( \frac{1}{{( 2 π )}^{n / 2}} exp ( - \frac{1}{2} {Z}^{T} Z ) ) \qquad Equation ( 4 )$$

$$= log ( \frac{1}{{( 2 π )}^{n / 2}} ) + log ( exp ( - \frac{1}{2} {Z}^{T} Z ) ) \qquad Equation ( 5 )$$

$$= - \frac{n}{2} log ( 2 π ) - \frac{1}{2} {Z}^{T} Z \qquad Equation ( 6 )$$

Since

$${Z}^{T} Z = {\sum }_{i = 1}^{n} {z}_{i}^{2} ,$$

we finally obtain:

$$log f ( Z ) = - \frac{n}{2} log ( 2 π ) - \frac{1}{2} {\sum }_{i = 1}^{n} {z}_{i}^{2} \qquad Equation ( 6 )$$

As a numerical example, suppose that an entity has 5 features with z-scores:

$${z}_{1} = 1.2 , {z}_{2} = - 0.5 , {z}_{3} = 0 \text{.8} , {z}_{4} = - 1.1 , {z}_{5} = 0.3$$

Then:

$$\sum {z}_{i}^{2} = 1 . {2}^{2} + {( - 0.5 )}^{2} + 0 . {8}^{2} + {( - 1.1 )}^{2} + 0 . {3}^{2} = 3 \text{.63}$$

$$log f ( Z ) = - \frac{5}{2} log ( 2 π ) - \frac{1}{2} \cdot 3.63$$

Since log(2π)≈1.837877, we get:

$$log f ( Z ) = - \frac{5}{2} \cdot 1.837877 - 1.815 = - 4.5946925 - 1.815 = - 6.4096925$$

The motivation for distribution as discussed above stems from traditional ML approaches on a data intake and query system that execute only on search heads. This creates bottlenecks and prevents horizontal scaling. The novel approaches herein instead push computation to the indexers using a search processing language, which aligns with the native distributed architecture of the data intake and query system.

The following provides a high-level distributed algorithm in a series of steps:
Step 1: Extract feature vectors X and Y using scheduled summary searches.
Step 2: Compute means μ and standard deviations σ of historical features at indexer tier.
Step 3: Standardize Y to get Z via eval commands.
Step 4: Compute squared sum

$$S = \sum {z}_{i}^{2}$$

and log-likelihood using eval.
Step 5: Flag anomalies when log-likelihood is below threshold.

It should be understood that several innovations were utilized in generating the scalable architecture disclosed herein including:
Closed-Form Computation: Avoids iterative ML training and supports real-time scoring.
Indexer-Level Computation: Leverages Splunk's parallelism at the ingestion tier.
Feature Abstractions: Decouples feature computation pipelines from detection logic.
Rolling Window Efficiency: Eliminates recomputation of 30-day vectors by storing intermediate aggregates.

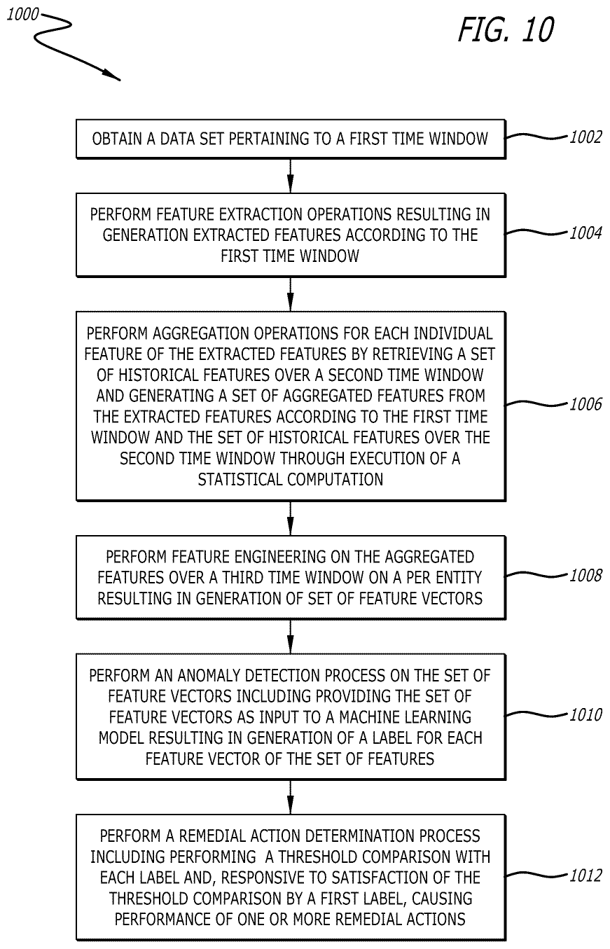

Referring now to FIG. 10, a flow diagram illustrating an exemplary embodiment of an anomaly detection process implemented by the anomaly detection subsystem 150 of FIGS. 1 and 2 is shown in accordance with various embodiments of the disclosure. FIG. 10 illustrates an example process 1000 of anomaly detection on ingested data using the anomaly detection subsystem of FIGS. 1 and 2. The example process 1000 may be implemented, for example, by a computing device that comprises one or more processors and non-transitory computer-readable medium and is specifically configured with the logic modules set forth in FIGS. 1 and 2. The non-transitory computer readable medium may store instructions that, when executed by the processor(s), cause the processor(s) to perform the operations of the illustrated process 1000.

Each block illustrated in FIG. 10 represents an operation of the process 1000. It should be understood that not every operation illustrated in FIG. 10 is required. In fact, certain operations may be optional to complete aspects of the process 1000. The process 1000 begins with an operations of obtaining a data set pertaining to a first time window and performing feature extraction operations resulting in generation extracted features according to the first time window (blocks 1002, 1004). Subsequently, aggregation operations are performed for each individual feature of the extracted features by retrieving a set of historical features over a second time window and generating a set of aggregated features from the extracted features according to the first time window and the set of historical features over the second time window through execution of a statistical computation (block 1006).

Feature engineering is then performed on the aggregated features over a third time window on a per entity resulting in generation of set of feature vectors, which is followed by performance of an anomaly detection process on the set of feature vectors including providing the set of feature vectors as input to a machine learning model resulting in generation of a label for each feature vector of the set of features (blocks 1008, 1010). Finally, a remedial action determination process is performed that includes performing a threshold comparison with each label and, responsive to satisfaction of the threshold comparison by a first label, causing performance of one or more remedial actions (block 1012).

In some embodiments, the method may include performing the feature aggregation operations on a rolling window. In other embodiments, the extracted features consist of mergeable features configured to be aggregated with corresponding past extracted features over the second time window. In some instances, each entity represents a user or a device. Additionally, in some examples, the extracted features generated by the feature extraction operations are stored in a first summary data store configured to be accessible to logic that is configured to perform the aggregation operations. In some implementations, the first time window is one hour and obtaining subsequent data sets pertaining to the first time window is performed at regular one hour intervals. In some implementations, the second time window is 24 hours, and the third time window is 30 days.

### F. System Component Examples

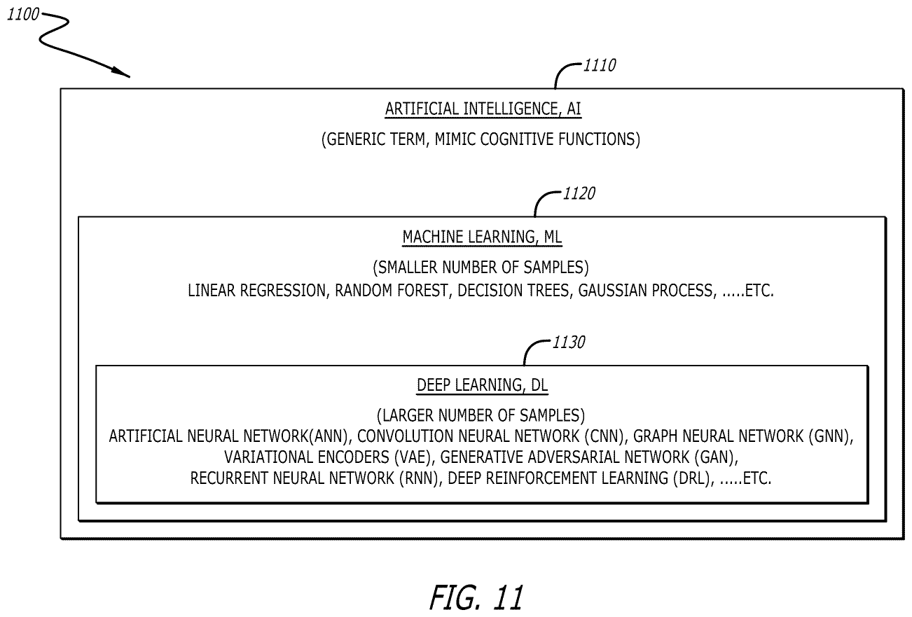

Referring to FIG. 11, a diagram 100 depicting various subsets of artificial intelligence in accordance with various embodiments of the disclosure is shown. Artificial intelligence (AI) 1110 is typically understood in the art to be the development of machines and algorithms that mimic human intelligence, for example, by optimizing actions to achieve certain goals. At its core, AI 1110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 1110 can be considered a generic term because it encompasses a wide range of subfields and techniques, from simple rule-based systems to advanced machine learning and deep learning models. These AI techniques are used to simulate various aspects of human cognition. For example, machine learning (ML) 1120 allows computers to learn from data patterns without explicit programming for each task, while natural language processing (NLP) enables machines to understand and generate human language. Deep learning (DL) 1130, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 1110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 1120 is a subset of Artificial Intelligence (AI) 1110 that focuses on the development of algorithms and statistical models that enable computers to learn and make decisions from data without explicit programming. In traditional programming, a computer is given a fixed set of rules to follow, but ML 1120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 1120. These algorithms can handle various data types, including numerical, categorical, and structured datasets like spreadsheets or grids. One of the key strengths of ML is its ability to generalize from the training data to make accurate predictions on new, unseen data.

However, traditional ML methods rely heavily on feature engineering, wherein human experts manually identify the most relevant features or patterns within the data. For example, when using ML 1120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 1130 is a specialized subset of Machine Learning (ML) 1120 that employs multi-layered artificial neural networks to automatically learn complex patterns and representations from large, often unstructured datasets. Inspired by the way the human brain processes information, DL 1130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 1130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of DL 1130 neural network designed to work particularly well with image data, making them highly relevant for image and video data processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction that is relevant to the underlying process being executed.

While CNNs are well-suited for grid-based data like images, many real-world problems can involve non-grid data. This type of data may better be represented as a graph, where nodes represent entities (e.g., specific items) and edges represent relationships between them (e.g., characteristics, values, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an entity or the properties of a related to that or associated entities.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This can allow for the generation of new data by sampling points from the latent space. Similarly, GANs often consist of two components: a generator that creates fake/generated data and a discriminator that tries to distinguish between real and fake data. The two components can be trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex data simulations. In various embodiments, DRL can be used in scenarios where an optimal decision needs to be made. The combination of RL and DL can allow for learning from raw data, making it a powerful tool for dynamic and real-time decision-making within various embodiments.

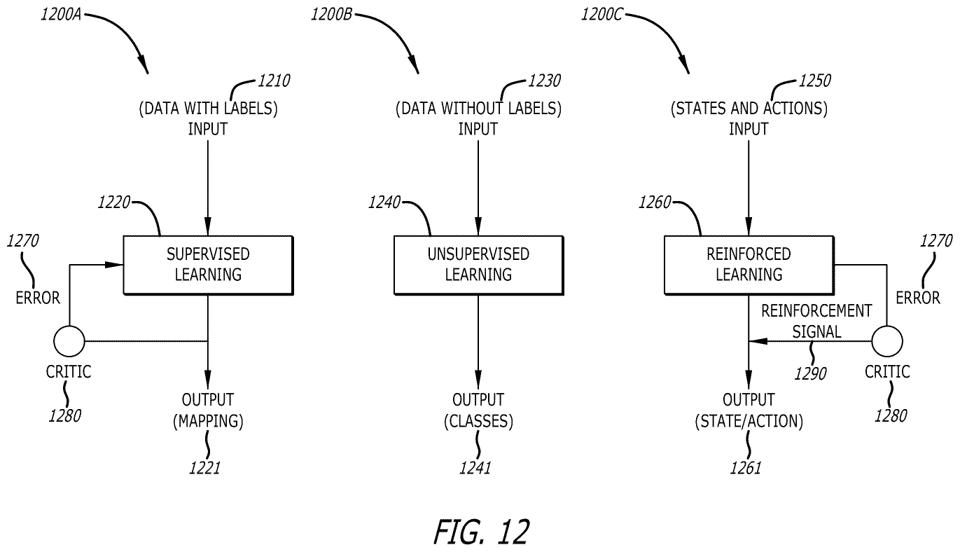

Although a specific embodiment for a diagram 1100 depicting various subsets of artificial intelligence suitable for carrying out the various steps, processes, methods, and operations described herein is discussed with respect to FIG. 11, any of a variety of systems and/or processes may be utilized in accordance with embodiments of the disclosure. For example, other subset may be present and available for use within AI 1110. Those skilled in the art will recognize that the diagram 1100 presented in FIG. 11 is simplified for illustration purposes and various methods and techniques may interact with other areas (ML 1120 with DL 1130, etc.). The elements depicted in FIG. 11 may also be interchangeable with other elements of FIGS. 12-3 as required to realize a particularly desired embodiment.

Referring to FIG. 12, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 12, a supervised learning system 1200A is shown. The supervised learning system 1200A can be configured with a supervised learning model 1220 that accepts input data 1210 and generates an output 1221. However, the output data is often reviewed by a critic 1280 that can determine one or more errors 1270 that are fed back into the supervised learning model 1220 for use in updating.

Supervised learning systems 1200A are often considered the simplest machine learning model to understand in which input data (such as training data) has a known label or result as an output. So, the supervised learning model 1220 can be understood to work on the principle of input-output pairs. As such, a function can be trained using a training data set, which is then applied to unknown data and makes some predictive performance. Supervised learning is task-based and mostly tested on labeled data sets.

Supervised learning systems 1200A may often involve one or more regression problems. In regression problems, the output is a continuous variable. Some commonly used Regression models include linear regression, decision trees, and random forests. Linear regression is typically the most straightforward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain routing pathway is optimal or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 12, an unsupervised learning system 1200B is shown. The unsupervised learning system 1200B can be configured with an unsupervised learning model 1240 that accepts input data 1230 and generates an output 1241. Unlike other model types, there are no critics or error signals to process. Unsupervised learning models 1240 can implement the learning process opposite to supervised learning, which means it enables the model to learn from an unlabeled training dataset. Based on the unlabeled dataset, the unsupervised learning model 1240 can predict the output. Using an unsupervised learning system 1200B, the unsupervised learning model 1240 can learn hidden patterns from the dataset by itself without any supervision. In various embodiments, unsupervised learning models 1240 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 12, a reinforcement learning system 1200C is shown. The reinforcement learning system 1200C can be configured with a reinforcement learning model 1260 that accepts input data 1250 and generates an output 1261. In reinforcement learning, the reinforcement learning model 1260 learns actions for a given set of states that lead to a goal state. In the embodiment depicted in FIG. 12, a critic 1280 can receive or otherwise notice an error 1270 within the reinforcement learning model 1260 actions, and provide a reinforcement signal 1290 corresponding to an evaluation of the actions. The reinforcement signal 1290 provides corrective information such as a “reward,” “punishment,” or error estimation to better model the future behaviors or processing of the reinforcement learning model 1260.

Described is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning include q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

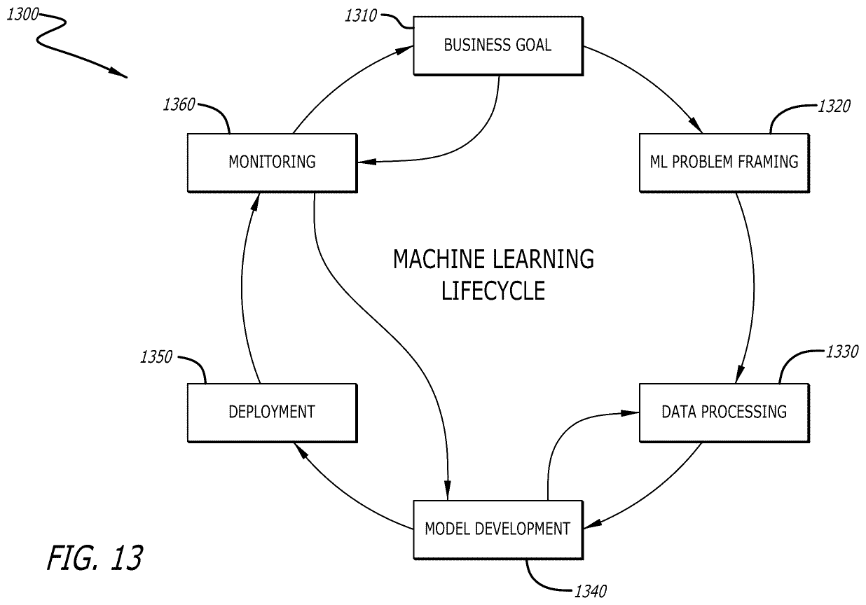

Although a specific embodiment for different methods of machine-based learning suitable for carrying out the various steps, processes, methods, and operations described herein is discussed with respect to FIG. 12, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 12 may also be interchangeable with other elements of FIGS. 11 and 13 as required to realize a particularly desired embodiment.

Referring to FIG. 13, a machine learning lifecycle 1300 in accordance with various embodiments of the disclosure is shown. During the development of machine learning systems, the embodiment depicted in FIG. 13 can provide a framework for how to structure the design and maintenance of these systems. This machine learning lifecycle 1300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 1300 emphasizes that developing a machine learning model is not a one-time effort but an iterative process requiring ongoing monitoring and adjustment. The feedback loop inherent in the machine learning lifecycle 1300 allows for continual refinement and optimization of models to maintain their accuracy and relevance.

In many embodiments, a first stage of the machine learning lifecycle 1300 is identifying the business goal 1310, which sets the overall direction and purpose of the ML project. This can involve understanding the specific problems or opportunities within the business or project that machine learning can address. A clear business goal 1310 ensures that the project remains focused on delivering tangible value. Without a well-defined goal, it can be challenging to align the subsequent stages of the ML lifecycle 1300, as the choice of model, data processing methods, and performance metrics can all depend on what the business aims to achieve.

Establishing a proper business goal 1310 can also involve engaging with key stakeholders and developers to gather requirements and set success criteria. It can provide a roadmap that outlines what success looks like and helps in framing the ML problem. Clearly defined goals not only help guide the project but also provide benchmarks for evaluating the effectiveness of the deployed model once it enters production.

Once the business goal 1310 is established, various embodiments take a next step involving ML problem framing 1320, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 1330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 1330 can require or at least benefit from careful planning and iterative refinement. Once the data is processed, it is typically split into training, validation, and test sets to develop and evaluate the model, ensuring that it generalizes well to new, unseen data.

Model development 1340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 1340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 1330.

In further embodiments, deployment 1350 is the stage where the developed model is integrated into the production environment to perform its intended tasks. This phase may involve setting up the necessary infrastructure, such as APIs or cloud-based services, to allow the model(s) to process live data and generate predictions. Deployment 1350 can transform the model from a research tool into a functional component of a business process or product, providing real-time insights, automations, or decisions.

Proper deployment 1350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 1310.

In more embodiments, monitoring 1360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 1360, teams can identify when the model's performance drops and requires retraining or adjustments to align with the evolving data.

Monitoring 1360 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 1330 and model development 1340, to refine the model(s) as needed. This iterative process allows the machine learning system to adapt and maintain its alignment with the original business goal 1310 over time.

Although a specific embodiment for a machine learning lifecycle 1300 suitable for carrying out the various steps, processes, methods, and operations described herein is discussed with respect to FIG. 13, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 13 may also be interchangeable with other elements of FIGS. 1-2 as required to realize a particularly desired embodiment.

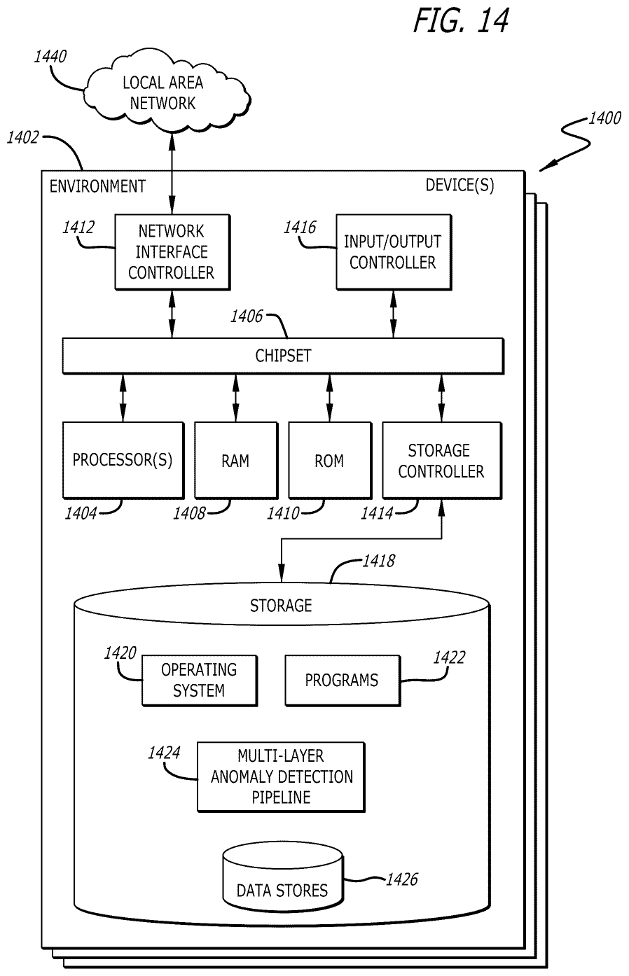

Referring now to FIG. 14, a conceptual block diagram of a device suitable for configuration with logic of the multi-layer anomaly detection subsystem 150 in accordance with various embodiments of the disclosure is shown. The embodiment of the conceptual block diagram depicted in FIG. 14 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 14 can also illustrate an access point, a switch, or a router in accordance with various embodiments of the disclosure. The device 1400 may, in many nonlimiting examples, correspond to physical devices or to virtual resources described herein.

In many embodiments, the device 1400 may include an environment 1402 such as a baseboard or “motherboard,” in physical embodiments that can be configured as a printed circuit board with a multitude of components or devices connected by way of a system bus or other electrical communication paths. Conceptually, in virtualized embodiments, the environment 1402 may be a virtual environment that encompasses and executes the remaining components and resources of the device 1400. In more embodiments, one or more processors 1404, such as, but not limited to, central processing units (“CPUs”) can be configured to operate in conjunction with a chipset 1406. The processor(s) 1404 can be standard programmable CPUs that perform arithmetic and logical operations necessary for the operation of the device 1400.

In a number of embodiments, the processor(s) 1404 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1406 may provide an interface between the processor(s) 1404 and the remainder of the components and devices within the environment 1402. The chipset 1406 can provide an interface to a random-access memory (“RAM”) 1408, which can be used as the main memory in the device 1400 in some embodiments. The chipset 1406 can further be configured to provide an interface to a computer-readable storage medium such as a read-only memory (“ROM”) 1410 or non-volatile RAM (“NVRAM”) for storing basic routines that can help with various tasks such as, but not limited to, starting up the device 1400 and/or transferring information between the various components and devices. The ROM 1410 or NVRAM can also store other application components necessary for the operation of the device 1400 in accordance with various embodiments described herein.

Additional embodiments of the device 1400 can be configured to operate in a networked environment using logical connections to remote computing devices and computer systems through a network, such as the network 1440. The chipset 1406 can include functionality for providing network connectivity through a network interface card (“NIC”) 1412, which may comprise a gigabit Ethernet adapter or similar component. The NIC 1412 can be capable of connecting the device 1400 to other devices over the network 1440. It is contemplated that multiple NICs 1412 may be present in the device 1400, connecting the device to other types of networks and remote systems.

In further embodiments, the device 1400 can be connected to a storage 1418 that provides non-volatile storage for data accessible by the device 1400. The storage 1418 can, for instance, store an operating system 1420, and programs 1422. In various embodiments, the storage 1418 includes logic modules encompassing logic of the multi-layer anomaly detection subsystem 150 and the summary and detection indexes (“data stores 1426”) as discussed above.

The storage 1418 can be connected to the environment 1402 through a storage controller 1414 connected to the chipset 1406. In certain embodiments, the storage 1418 can consist of one or more physical storage units. The storage controller 1414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1400 can store data within the storage 1418 by transforming the physical state of the physical storage units to reflect the information being stored. The specific transformation of physical state can depend on various factors. Examples of such factors can include, but are not limited to, the technology used to implement the physical storage units, whether the storage 1418 is characterized as primary or secondary storage, and the like.

In many more embodiments, the device 1400 can store information within the storage 1418 by issuing instructions through the storage controller 1414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1400 can further read or access information from the storage 1418 by detecting the physical states or characteristics of one or more particular locations within the physical storage units.

In addition to the storage 1418 described above, the device 1400 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1400. In some examples, the operations performed by a cloud computing network, and or any components included therein, may be supported by one or more devices similar to device 1400. Stated otherwise, some or all of the operations performed by the cloud computing network, and or any components included therein, may be performed by one or more devices 1400 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM ((“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1418 can store an operating system 1420 utilized to control the operation of the device 1400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1418 can store other system or application programs and data utilized by the device 1400.

In many additional embodiments, the storage 1418 or other computer-readable storage media is encoded with computer-executable instructions which, when loaded into the device 1400, may transform it from a general-purpose computing system into a special-purpose computer capable of implementing the embodiments described herein. These computer executable instructions may be stored as program 1422 (for example, an application) and transform the device 1400 by specifying how the processor(s) 1404 can transition between states, as described above. In some embodiments, the device 1400 has access to computer-readable storage media storing computer executable instructions which, when executed by the device 1400, perform the various processes described above with regard to any of the figures discussed herein. In certain embodiments, the device 1400 can also include computer-readable storage media having instructions stored thereupon for performing any of the other computer-implemented operations described herein.

In still further embodiments, the device 1400 can also include one or more input/output controllers 1416 for receiving and processing input from a number of input devices, such as a keyboard, a mouse, a touchpad, a touch screen, an electronic stylus, or other type of input device. Similarly, an input/output controller 1416 can be configured to provide output to a display, such as a computer monitor, a flat panel display, a digital projector, a printer, or other type of output device. Those skilled in the art will recognize that the device 1400 might not include all of the components shown in FIG. 14 and can include other components that are not explicitly shown in FIG. 14 or might utilize an architecture completely different than that shown in FIG. 14.

As described above, the device 1400 may support a virtualization layer, such as one or more virtual resources executing on the device 1400. In some examples, the virtualization layer may be supported by a hypervisor that provides one or more virtual machines running on the device 1400 to perform functions described herein. The virtualization layer may generally support a virtual resource that performs at least a portion of the techniques described herein.

Although a specific embodiment for a device suitable for configuration with logic of an AI system for carrying out the various steps, processes, methods, and operations described herein is discussed with respect to FIG. 14, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 14 may also be interchangeable with other elements of the disclosure as appropriate to realize a particularly desired embodiment.

### G. Data Intake and Query Architecture and Use Cases

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Collection and analysis of the data from a computing environment can be performed by a data intake and query system such as is described herein. A data intake and query system can ingest and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics.

FIG. 15 is a block diagram illustrating an example computing environment 1500 that includes a data intake and query system 1510. The data intake and query system 1510 obtains data from a data source 1502 in the computing environment 1500 and ingests the data using an indexing system 1520. A search system 1560 of the data intake and query system 1510 enables users to navigate the indexed data. Though drawn with separate boxes in FIG. 15, in some implementations the indexing system 1520 and the search system 1560 can have overlapping components. A computing device 1504, running a network access application 1506, can communicate with the data intake and query system 1510 through a user interface system 1514 of the data intake and query system 1510. Using the computing device 1504, a user can perform various operations with respect to the data intake and query system 1510, such as administration of the data intake and query system 1510, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 1510 can further optionally include apps 1512 that extend the search, analytics, and/or visualization capabilities of the data intake and query system 1510.

The data intake and query system 1510 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 1510 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 1510 can be executed on a single computing device, or execution of the program code can be distributed over multiple computing devices. For example, the program code can include instructions for both indexing and search components (which may be part of the indexing system 1520 and/or the search system 1560, respectively), which can be executed on a computing device that also provides the data source 1502. As another example, the program code can be executed on one computing device, where execution of the program code provides both indexing and search components, while another copy of the program code executes on a second computing device that provides the data source 1502. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 1502 of the computing environment 1500 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 1502 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 1520 obtains machine date from the data source 1502 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 1520 does not require prior knowledge of the structure of incoming data (e.g., the indexing system 1520 does not need to be provided with a schema describing the data). Additionally, the indexing system 1520 retains a copy of the data as it was received by the indexing system 1520 such that the original data is always available for searching (e.g., no data is discarded, though, in some examples, the indexing system 1520 can be configured to do so).

The search system 1560 searches the data stored by the indexing system 1520. As discussed in greater detail below, the search system 1560 enables users associated with the computing environment 1500 (and possibly also other users) to navigate the data, generate reports, and visualize search results in “dashboards” output using a graphical interface. Using the facilities of the search system 1560, users can obtain insights about the data, such as retrieving events from an index, calculating metrics, searching for specific conditions within a rolling time window, identifying patterns in the data, and predicting future trends, among other examples. To achieve greater efficiency, the search system 1560 can apply map-reduce methods to parallelize searching of large volumes of data. Additionally, because the original data is available, the search system 1560 can apply a schema to the data at search time. This allows different structures to be applied to the same data, or for the structure to be modified if or when the content of the data changes. Application of a schema at search time may be referred to herein as a late-binding schema technique.

The user interface system 1514 provides mechanisms through which users associated with the computing environment 1500 (and possibly others) can interact with the data intake and query system 1510. These interactions can include configuration, administration, and management of the indexing system 1520, initiation and/or scheduling of queries that are to be processed by the search system 1560, receipt or reporting of search results, and/or visualization of search results. The user interface system 1514 can include, for example, facilities to provide a command line interface or a web-based interface.

Users can access the user interface system 1514 using a computing device 1504 that communicates with data intake and query system 1510, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 1500. For example, a person can log in as a particular user and, using the user's digital information, can access the data intake and query system 1510. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users' digital information, including assignment of user identifiers, management of security credentials, control of which persons are associated with which users, and so on.

The computing device 1504 can provide a human-machine interface through which a person can have a digital presence in the computing environment 1500 in the form of a user. The computing device 1504 is an electronic device having one or more processors and a memory capable of storing instructions for execution by the one or more processors. The computing device 1504 can further include input/output (I/O) hardware and a network interface. Applications executed by the computing device 1504 can include a network access application 1506, such as a web browser, which can use a network interface of the client computing device 1504 to communicate, over a network, with the user interface system 1514 of the data intake and query system 1510. The user interface system 1514 can use the network access application 1506 to generate user interfaces that enable a user to interact with the data intake and query system 1510. A web browser is one example of a network access application. A shell tool can also be used as a network access application. In some examples, the data intake and query system 1510 is an application executing on the computing device 1504. In such examples, the network access application 1506 can access the user interface system 1514 without going over a network.

The data intake and query system 1510 can optionally include apps 1512. An app of the data intake and query system 1510 is a collection of configurations, knowledge objects (a user-defined entity that enriches the data in the data intake and query system 1510), views, and dashboards that may provide additional functionality, different techniques for searching the data, and/or additional insights into the data. The data intake and query system 1510 can execute multiple applications simultaneously. Example applications include an information technology service intelligence application, which can monitor and analyze the performance and behavior of the computing environment 1500, and an enterprise security application, which can include content and searches to assist security analysts in diagnosing and acting on anomalous or malicious behavior in the computing environment 1500.

Though FIG. 15 illustrates only one data source, in practical implementations, the computing environment 1500 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 1500, the data intake and query system 1510 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 1500 can include on-prem and cloud-based computing resources, or only cloud-based resources. For example, an entity may have on-prem computing devices and a private cloud. In this example, the entity operates the data intake and query system 1510 and can choose to execute the data intake and query system 1510 on an on-prem computing device or in the cloud. In another example, a provider entity operates the data intake and query system 1510 in a public cloud and provides the functionality of the data intake and query system 1510 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 1510. In some implementations, the entity providing the data intake and query system 1510 is itself subscribing to the cloud services of a cloud service provider. As an example, a first entity provides computing resources under a public cloud service model, a second entity subscribes to the cloud services of the first provider entity and uses the cloud computing resources to operate the data intake and query system 1510, and a third entity can subscribe to the services of the second provider entity in order to use the functionality of the data intake and query system 1510. In this example, the data sources are associated with the third entity, users accessing the data intake and query system 1510 are associated with the third entity, and the analytics and insights provided by the data intake and query system 1510 are for purposes of the third entity's operations.

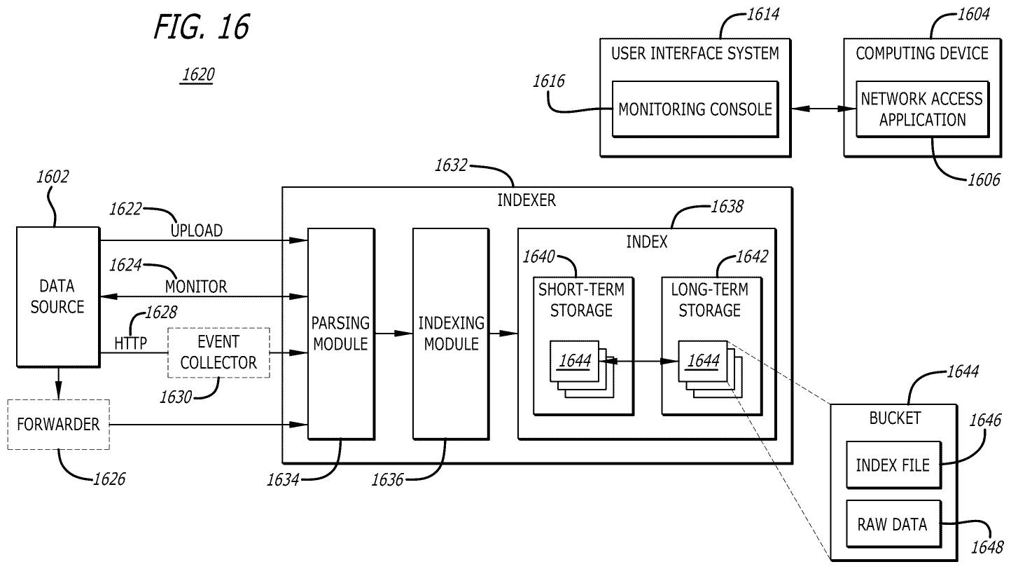

FIG. 16 is a block diagram illustrating in greater detail an example of an indexing system 1620 of a data intake and query system, such as the data intake and query system 1510 of FIG. 15. The indexing system 1620 of FIG. 16 uses various methods to obtain machine data from a data source 1602 and stores the data in an index 1638 of an indexer 1632. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 1620 enables the data intake and query system to obtain the machine data produced by the data source 1602 and to store the data for searching and retrieval.

Users can administer the operations of the indexing system 1620 using a computing device 1604 that can access the indexing system 1620 through a user interface system 1614 of the data intake and query system. For example, the computing device 1604 can be executing a network access application 1606, such as a web browser or a terminal, through which a user can access a monitoring console 1616 provided by the user interface system 1614. The monitoring console 1616 can enable operations such as: identifying the data source 1602 for data ingestion; configuring the indexer 1632 to index the data from the data source 1632; configuring a data ingestion method; configuring, deploying, and managing clusters of indexers; and viewing the topology and performance of a deployment of the data intake and query system, among other operations. The operations performed by the indexing system 1620 may be referred to as “index time” operations, which are distinct from “search time” operations that are discussed further below.

The indexer 1632, which may be referred to herein as a data indexing component, coordinates and performs most of the index time operations. The indexer 1632 can be implemented using program code that can be executed on a computing device. The program code for the indexer 1632 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 1632. In some implementations, the indexer 1632 executes on the computing device 1604 through which a user can access the indexing system 1620. In some implementations, the indexer 1632 executes on a different computing device than the illustrated computing device 1604.

The indexer 1632 may be executing on the computing device that also provides the data source 1602 or may be executing on a different computing device. In implementations wherein the indexer 1632 is on the same computing device as the data source 1602, the data produced by the data source 1602 may be referred to as “local data.” In other implementations the data source 1602 is a component of a first computing device and the indexer 1632 executes on a second computing device that is different from the first computing device. In these implementations, the data produced by the data source 1602 may be referred to as “remote data.” In some implementations, the first computing device is “on-prem” and in some implementations the first computing device is “in the cloud.” In some implementations, the indexer 1632 executes on a computing device in the cloud and the operations of the indexer 1632 are provided as a service to entities that subscribe to the services provided by the data intake and query system.

For a given data produced by the data source 1602, the indexing system 1620 can be configured to use one of several methods to ingest the data into the indexer 1632. These methods include upload 1622, monitor 1624, using a forwarder 1626, or using HyperText Transfer Protocol (HTTP 1628) and an event collector 1630. These and other methods for data ingestion may be referred to as “getting data in” (GDI) methods.

Using the upload 1622 method, a user can specify a file for uploading into the indexer 1632. For example, the monitoring console 1616 can include commands or an interface through which the user can specify where the file is located (e.g., on which computing device and/or in which directory of a file system) and the name of the file. The file may be located at the data source 1602 or maybe on the computing device where the indexer 1632 is executing. Once uploading is initiated, the indexer 1632 processes the file, as discussed further below. Uploading is a manual process and occurs when instigated by a user. For automated data ingestion, the other ingestion methods are used.

The monitor 1624 method enables the indexer 1632 to monitor the data source 1602 and continuously or periodically obtain data produced by the data source 1602 for ingestion by the indexer 1632. For example, using the monitoring console 1616, a user can specify a file or directory for monitoring. In this example, the indexer 1632 can execute a monitoring process that detects whenever the file or directory is modified and causes the file or directory contents to be sent to the indexer 1632. As another example, a user can specify a network port for monitoring. In this example, a monitoring process can capture data received at or transmitting from the network port and cause the data to be sent to the indexer 1632. In various examples, monitoring can also be configured for data sources such as operating system event logs, performance data generated by an operating system, operating system registries, operating system directory services, and other data sources.

Monitoring is available when the data source 1602 is local to the indexer 1632 (e.g., the data source 1602 is on the computing device where the indexer 1632 is executing). Other data ingestion methods, including forwarding and the event collector 1630, can be used for either local or remote data sources.

A forwarder 1626, which may be referred to herein as a data forwarding component, is a software process that sends data from the data source 1602 to the indexer 1632. The forwarder 1626 can be implemented using program code that can be executed on the computer device that provides the data source 1602. A user launches the program code for the forwarder 1626 on the computing device that provides the data source 1602. The user can further configure the forwarder 1626, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 1626 can provide various capabilities. For example, the forwarder 1626 can send the data unprocessed or can perform minimal processing on the data before sending the data to the indexer 1632. Minimal processing can include, for example, adding metadata tags to the data to identify a source, source type, and/or host, among other information, dividing the data into blocks, and/or applying a timestamp to the data. In some implementations, the forwarder 1626 can break the data into individual events (event generation is discussed further below) and send the events to a receiver. Other operations that the forwarder 1626 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator)

The event collector 1630 provides an alternate method for obtaining data from the data source 1602. The event collector 1630 enables data and application events to be sent to the indexer 1632 using HTTP 1628. The event collector 1630 can be implemented using program code that can be executing on a computing device. The program code may be a component of the data intake and query system or can be a standalone component that can be executed independently of the data intake and query system and operates in cooperation with the data intake and query system.

To use the event collector 1630, a user can, for example using the monitoring console 1616 or a similar interface provided by the user interface system 1614, enable the event collector 1630 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 1602 as an alternative method to using a username and password for authentication.

To send data to the event collector 1630, the data source 1602 is supplied with a token and can then send HTTP 1628 requests to the event collector 1630. To send HTTP 1628 requests, the data source 1602 can be configured to use an HTTP client and/or to use logging libraries such as those supplied by Java, JavaScript, and .NET libraries. An HTTP client enables the data source 1602 to send data to the event collector 1630 by supplying the data, and a Uniform Resource Identifier (URI) for the event collector 1630 to the HTTP client. The HTTP client then handles establishing a connection with the event collector 1630, transmitting a request containing the data, closing the connection, and receiving an acknowledgment if the event collector 1630 sends one. Logging libraries enable HTTP 1628 requests to the event collector 1630 to be generated directly by the data source. For example, an application can include or link a logging library, and through functionality provided by the logging library manage establishing a connection with the event collector 1630, transmitting a request, and receiving an acknowledgement.

An HTTP 1628 request to the event collector 1630 can contain a token, a channel identifier, event metadata, and/or event data. The token authenticates the request with the event collector 1630. The channel identifier, if available in the indexing system 1620, enables the event collector 1630 to segregate and keep separate data from different data sources. The event metadata can include one or more key-value pairs that describe the data source 1602 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 1630 extracts events from HTTP 1628 requests and sends the events to the indexer 1632. The event collector 1630 can further be configured to send events to one or more indexers. Extracting the events can include associating any metadata in a request with the event or events included in the request. In these implementations, event generation by the indexer 1632 (discussed further below) is bypassed, and the indexer 1632 moves the events directly to indexing. In some implementations, the event collector 1630 extracts event data from a request and outputs the event data to the indexer 1632, and the indexer generates events from the event data. In some implementations, the event collector 1630 sends an acknowledgement message to the data source 1602 to indicate that the event collector 1630 has received a particular request form the data source 1602, and/or to indicate to the data source 1602 that events in the request have been added to an index.

The indexer 1632 ingests incoming data and transforms the data into searchable knowledge in the form of events. In the data intake and query system, an event is a single piece of data that represents activity of the component represented in FIG. 16 by the data source 1602. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 1632 can include a parsing module 1634 and an indexing module 1636 for generating and storing the events. The parsing module 1634 and indexing module 1636 can be modular and pipelined, such that one component can be operating on a first set of data while the second component is simultaneously operating on a second sent of data. Additionally, the indexer 1632 may at any time have multiple instances of the parsing module 1634 and indexing module 1636, with each set of instances configured to simultaneously operate on data from the same data source or from different data sources. The parsing module 1634 and indexing module 1636 are illustrated in FIG. 16 to facilitate discussion, with the understanding that implementations with other components are possible to achieve the same functionality.

The parsing module 1634 determines information about incoming event data, where the information can be used to identify events within the event data. For example, the parsing module 1634 can associate a source type with the event data. A source type identifies the data source 1602 and describes a possible data structure of event data produced by the data source 1602. For example, the source type can indicate which fields to expect in events generated at the data source 1602 and the keys for the values in the fields, and possibly other information such as sizes of fields, an order of the fields, a field separator, and so on. The source type of the data source 1602 can be specified when the data source 1602 is configured as a source of event data. Alternatively, the parsing module 1634 can determine the source type from the event data, for example from an event field in the event data or using machine learning techniques applied to the event data.

Other information that the parsing module 1634 can determine includes timestamps. In some cases, an event includes a timestamp as a field, and the timestamp indicates a point in time when the action represented by the event occurred or was recorded by the data source 1602 as event data. In these cases, the parsing module 1634 may be able to determine from the source type associated with the event data that the timestamps can be extracted from the events themselves. In some cases, an event does not include a timestamp and the parsing module 1634 determines a timestamp for the event, for example from a name associated with the event data from the data source 1602 (e.g., a file name when the event data is in the form of a file) or a time associated with the event data (e.g., a file modification time). As another example, when the parsing module 1634 is not able to determine a timestamp from the event data, the parsing module 1634 may use the time at which it is indexing the event data. As another example, the parsing module 1634 can use a user-configured rule to determine the timestamps to associate with events.

The parsing module 1634 can further determine event boundaries. In some cases, a single line (e.g., a sequence of characters ending with a line termination) in event data represents one event while in other cases, a single line represents multiple events. In yet other cases, one event may span multiple lines within the event data. The parsing module 1634 may be able to determine event boundaries from the source type associated with the event data, for example from a data structure indicated by the source type. In some implementations, a user can configure rules the parsing module 1634 can use to identify event boundaries.

The parsing module 1634 can further extract data from events and possibly also perform transformations on the events. For example, the parsing module 1634 can extract a set of fields (key-value pairs) for each event, such as a host or hostname, source or source name, and/or source type. The parsing module 1634 may extract certain fields by default or based on a user configuration. Alternatively or additionally, the parsing module 1634 may add fields to events, such as a source type or a user-configured field. As another example of a transformation, the parsing module 1634 can anonymize fields in events to mask sensitive information, such as social security numbers or account numbers. Anonymizing fields can include changing or replacing values of specific fields. The parsing module 1634 can further perform user-configured transformations.

The parsing module 1634 outputs the results of processing incoming event data to the indexing module 1636, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 1632 can be configured to identify searchable segments that are parts of fields, searchable segments that are entire fields, or both. The parsing module 1634 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 1646, to find event data that matches a search query. In some implementations, segmentation can alternatively be performed by the forwarder 1626. Segmentation can also be disabled, in which case the indexer 1632 will not build a lexicon for the event data. When segmentation is disabled, the search system searches the event data directly.

Building index data structures generates the index 1638. The index 1638 is a storage data structure on a storage device (e.g., a disk drive or other physical device for storing digital data). The storage device may be a component of the computing device on which the indexer 1632 is operating (referred to herein as local storage) or may be a component of a different computing device (referred to herein as remote storage) that the indexer 1632 has access to over a network. The indexer 1632 can manage more than one index and can manage indexes of different types. For example, the indexer 1632 can manage event indexes, which impose minimal structure on stored data and can accommodate any type of data. As another example, the indexer 1632 can manage metrics indexes, which use a highly structured format to handle the higher volume and lower latency demands associated with metrics data.

The indexing module 1636 organizes files in the index 1638 in directories referred to as buckets. The files in a bucket 1644 can include raw data files, index files, and possibly also other metadata files. As used herein, “raw data” means data as when the data was produced by the data source 1602, without alteration to the format or content. As noted previously, the parsing module 1634 may add fields to event data and/or perform transformations on fields in the event data. Event data that has been altered in this way is referred to herein as enriched data. A raw data file 1648 can include enriched data, in addition to or instead of raw data. The raw data file 1648 may be compressed to reduce disk usage. An index file 1646, which may also be referred to herein as a “time-series index” or tsidx file, contains metadata that the indexer 1632 can use to search a corresponding raw data file 1648. As noted above, the metadata in the index file 1646 includes a lexicon of the event data, which associates each unique keyword in the event data with a reference to the location of event data within the raw data file 1648. The keyword data in the index file 1646 may also be referred to as an inverted index. In various implementations, the data intake and query system can use index files for other purposes, such as to store data summarizations that can be used to accelerate searches.

A bucket 1644 includes event data for a particular range of time. The indexing module 1636 arranges buckets in the index 1638 according to the age of the buckets, such that buckets for more recent ranges of time are stored in short-term storage 1640 and buckets for less recent ranges of time are stored in long-term storage 1642. Short-term storage 1640 may be faster to access while long-term storage 1642 may be slower to access. Buckets may be moves from short-term storage 1640 to long-term storage 1642 according to a configurable data retention policy, which can indicate at what point in time a bucket is old enough to be moved.

A bucket's location in short-term storage 1640 or long-term storage 1642 can also be indicated by the bucket's status. As an example, a bucket's status can be “hot,” “warm,” “cold,” “frozen,” or “thawed.” In this example, hot bucket is one to which the indexer 1632 is writing data and the bucket becomes a warm bucket when the index 1632 stops writing data to it. In this example, both hot and warm buckets reside in short-term storage 1640. Continuing this example, when a warm bucket is moved to long-term storage 1642, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 1620 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each buckets must exist within the cluster), and indexers to which buckets are copied may be selected to optimize distribution of data across the cluster.

A user can view the performance of the indexing system 1620 through the monitoring console 1616 provided by the user interface system 1614. Using the monitoring console 1616, the user can configure and monitor an index cluster, and see information such as disk usage by an index, volume usage by an indexer, index and volume size over time, data age, statistics for bucket types, and bucket settings, among other information.

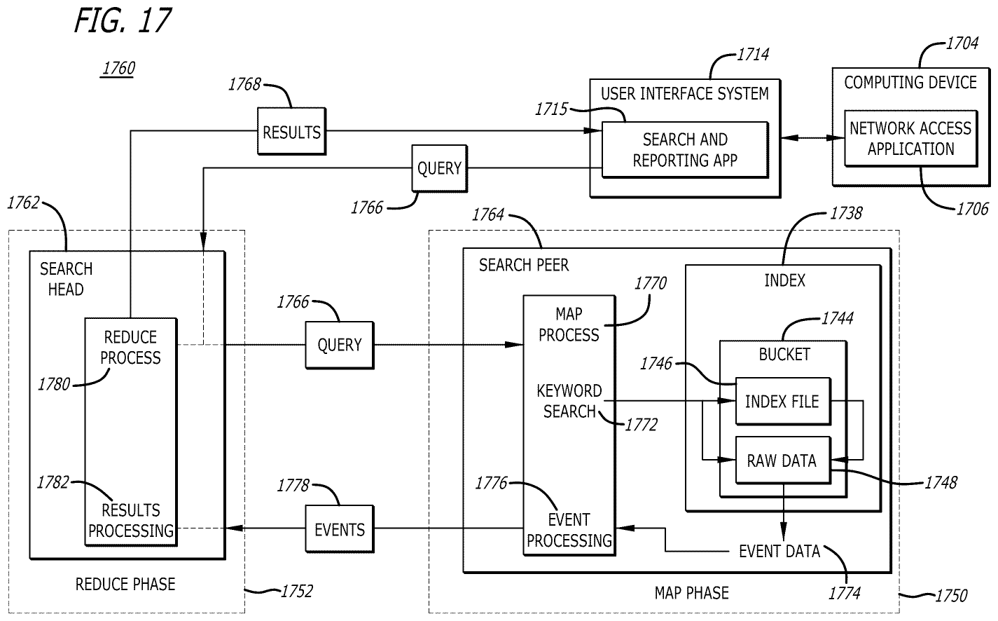

FIG. 17 is a block diagram illustrating in greater detail an example of the search system 1760 of a data intake and query system, such as the data intake and query system 1510 of FIG. 15. The search system 1760 of FIG. 17 issues a query 1766 to a search head 1762, which sends the query 1766 to a search peer 1764. Using a map process 1770, the search peer 1764 searches the appropriate index 1738 for events identified by the query 1766 and sends events 1778 so identified back to the search head 1762. Using a reduce process 1782, the search head 1762 processes the events 1778 and produces results 1768 to respond to the query 1766. The results 1768 can provide useful insights about the data stored in the index 1738. These insights can aid in the administration of information technology systems, in security analysis of information technology systems, and/or in analysis of the development environment provided by information technology systems.

The query 1766 that initiates a search is produced by a search and reporting app 1716 that is available through the user interface system 1714 of the data intake and query system. Using a network access application 1706 executing on a computing device 1704, a user can input the query 1766 into a search field provided by the search and reporting app 1716. Alternatively or additionally, the search and reporting app 1716 can include pre-configured queries or stored queries that can be activated by the user. In some cases, the search and reporting app 1716 initiates the query 1766 when the user enters the query 1766. In these cases, the query 1766 maybe referred to as an “ad-hoc” query. In some cases, the search and reporting app 1716 initiates the query 1766 based on a schedule. For example, the search and reporting app 1716 can be configured to execute the query 1766 once per hour, once per day, at a specific time, on a specific date, or at some other time that can be specified by a date, time, and/or frequency. These types of queries maybe referred to as scheduled queries.

The query 1766 is specified using a search processing language. The search processing language includes commands or search terms that the search peer 1764 will use to identify events to return in the search results 1768. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 1766 to include sequential commands, where a subsequent command may operate on the results of a prior command. As an example, sequential commands may be separated in the query 1766 by a vertical line (“|” or “pipe”) symbol.

In addition to one or more search commands, the query 1766 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 1766 occurs in two broad phases: a map phase 1750 and a reduce phase 1752. The map phase 1750 takes place across one or more search peers. In the map phase 1750, the search peers locate event data that matches the search terms in the search query 1766 and sorts the event data into field-value pairs. When the map phase 1750 is complete, the search peers send events that they have found to one or more search heads for the reduce phase 1752. During the reduce phase 1752, the search heads process the events through commands in the search query 1766 and aggregate the events to produce the final search results 1768.

A search head, such as the search head 1762 illustrated in FIG. 17, is a component of the search system 1760 that manages searches. The search head 1762, which may also be referred to herein as a search management component, can be implemented using program code that can be executed on a computing device. The program code for the search head 1762 can be stored on a non-transitory computer-readable medium and from this medium can be loaded or copied to the memory of a computing device. One or more hardware processors of the computing device can read the program code from the memory and execute the program code in order to implement the operations of the search head 1762.

Upon receiving the search query 1766, the search head 1762 directs the query 1766 to one or more search peers, such as the search peer 1764 illustrated in FIG. 17. “Search peer” is an alternate name for “indexer” and a search peer may be largely similar to the indexer described previously. The search peer 1764 may be referred to as a “peer node” when the search peer 1764 is part of an indexer cluster. The search peer 1764, which may also be referred to as a search execution component, can be implemented using program code that can be executed on a computing device. In some implementations, one set of program code implements both the search head 1762 and the search peer 1764 such that the search head 1762 and the search peer 1764 form one component. In some implementations, the search head 1762 is an independent piece of code that performs searching and no indexing functionality. In these implementations, the search head 1762 may be referred to as a dedicated search head.

The search head 1762 may consider multiple criteria when determining whether to send the query 1766 to the particular search peer 1764. For example, the search system 1760 may be configured to include multiple search peers that each have duplicative copies of at least some of the event data and are implanted using different hardware resources q. In this example, the sending the search query 1766 to more than one search peer allows the search system 1760 to distribute the search workload across different hardware resources. As another example, search system 1760 may include different search peers for different purposes (e.g., one has an index storing a first type of data or from a first data source while a second has an index storing a second type of data or from a second data source). In this example, the search query 1766 may specify which indexes to search, and the search head 1762 will send the query 1766 to the search peers that have those indexes.

To identify events 1778 to send back to the search head 1762, the search peer 1764 performs a map process 1770 to obtain event data 1774 from the index 1738 that is maintained by the search peer 1764. During a first phase of the map process 1770, the search peer 1764 identifies buckets that have events that are described by the time indicator in the search query 1766. As noted above, a bucket contains events whose timestamps fall within a particular range of time. For each bucket 1744 whose events can be described by the time indicator, during a second phase of the map process 1770, the search peer 1764 performs a keyword search 1772 using search terms specified in the search query 1766. The search terms can be one or more of keywords, phrases, fields, Boolean expressions, and/or comparison expressions that in combination describe events being searched for. When segmentation is enabled at index time, the search peer 1764 performs the keyword search 1772 on the bucket's index file 1746. As noted previously, the index file 1746 includes a lexicon of the searchable terms in the events stored in the bucket's raw data 1748 file. The keyword search 1772 searches the lexicon for searchable terms that correspond to one or more of the search terms in the query 1766. As also noted above, the lexicon incudes, for each searchable term, a reference to each location in the raw data 1748 file where the searchable term can be found. Thus, when the keyword search identifies a searchable term in the index file 1746 that matches a search term in the query 1766, the search peer 1764 can use the location references to extract from the raw data 1748 file the event data 1774 for each event that include the searchable term.

In cases where segmentation was disabled at index time, the search peer 1764 performs the keyword search 1772 directly on the raw data 1748 file. To search the raw data 1748, the search peer 1764 may identify searchable segments in events in a similar manner as when the data was indexed. Thus, depending on how the search peer 1764 is configured, the search peer 1764 may look at event fields and/or parts of event fields to determine whether an event matches the query 1766. Any matching events can be added to the event data 1774 read from the raw data 1748 file. The search peer 1764 can further be configured to enable segmentation at search time, so that searching of the index 1738 causes the search peer 1764 to build a lexicon in the index file 1746.

The event data 1774 obtained from the raw data 1748 file includes the full text of each event found by the keyword search 1772. During a third phase of the map process 1770, the search peer 1764 performs event processing 1776 on the event data 1774, with the steps performed being determined by the configuration of the search peer 1764 and/or commands in the search query 1766. For example, the search peer 1764 can be configured to perform field discovery and field extraction. Field discovery is a process by which the search peer 1764 identifies and extracts key-value pairs from the events in the event data 1774. The search peer 1764 can, for example, be configured to automatically extract the first 100 fields (or another number of fields) in the event data 1774 that can be identified as key-value pairs. As another example, the search peer 1764 can extract any fields explicitly mentioned in the search query 1766. The search peer 1764 can, alternatively or additionally, be configured with particular field extractions to perform.

Other examples of steps that can be performed during event processing 1776 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 1764 sends processed events 1778 to the search head 1762, which performs a reduce process 1780. The reduce process 1780 potentially receives events from multiple search peers and performs various results processing 1782 steps on the received events. The results processing 1782 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 1782 can further include applying commands from the search query 1766 to the events. The query 1766 can include, for example, commands for evaluating and/or manipulating fields (e.g., to generate new fields from existing fields or parse fields that have more than one value). As another example, the query 1766 can include commands for calculating statistics over the events, such as counts of the occurrences of fields, or sums, averages, ranges, and so on, of field values. As another example, the query 1766 can include commands for generating statistical values for purposes of generating charts of graphs of the events.

The reduce process 1780 outputs the events found by the search query 1766, as well as information about the events. The search head 1762 transmits the events and the information about the events as search results 1768, which are received by the search and reporting app 1716. The search and reporting app 1716 can generate visual interfaces for viewing the search results 1768. The search and reporting app 1716 can, for example, output visual interfaces for the network access application 1706 running on a computing device 1704 to generate.

The visual interfaces can include various visualizations of the search results 1768, such as tables, line or area charts, Choropleth maps, or single values. The search and reporting app 1716 can organize the visualizations into a dashboard, where the dashboard includes a panel for each visualization. A dashboard can thus include, for example, a panel listing the raw event data for the events in the search results 1768, a panel listing fields extracted at index time and/or found through field discovery along with statistics for those fields, and/or a timeline chart indicating how many events occurred at specific points in time (as indicated by the timestamps associated with each event). In various implementations, the search and reporting app 1716 can provide one or more default dashboards. Alternatively or additionally, the search and reporting app 1716 can include functionality that enables a user to configure custom dashboards.

The search and reporting app 1716 can also enable further investigation into the events in the search results 1768. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 1766. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

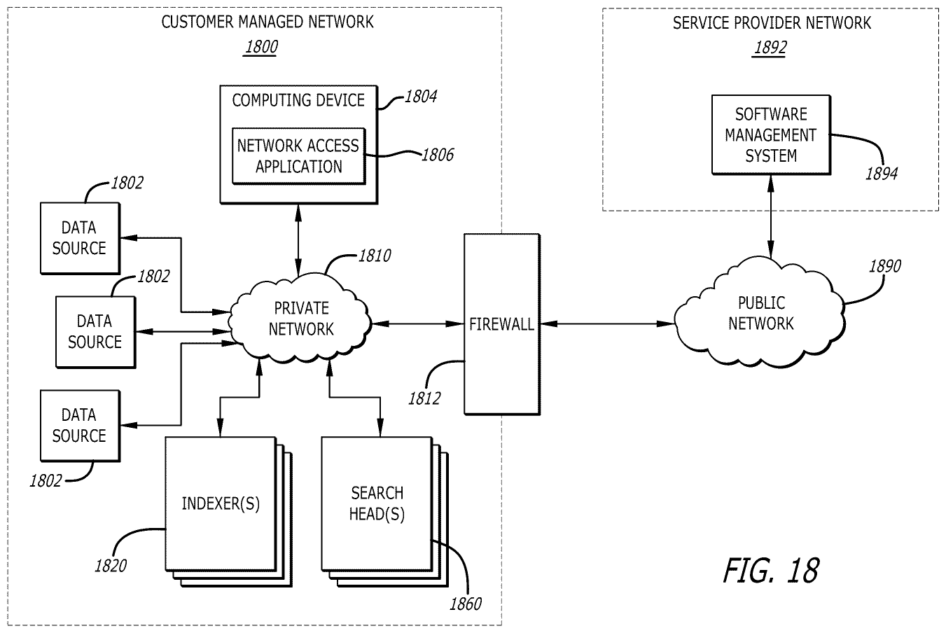

FIG. 18 illustrates an example of a self-managed network 1800 that includes a data intake and query system. “Self-managed” in this instance means that the entity that is operating the self-managed network 1800 configures, administers, maintains, and/or operates the data intake and query system using its own compute resources and people. Further, the self-managed network 1800 of this example is part of the entity's on-premise network and comprises a set of compute, memory, and networking resources that are located, for example, within the confines of an entity's data center. These resources can include software and hardware resources. The entity can, for example, be a company or enterprise, a school, government entity, or other entity. Since the self-managed network 1800 is located within the customer's on-prem environment, such as in the entity's data center, the operation and management of the self-managed network 1800, including of the resources in the self-managed network 1800, is under the control of the entity. For example, administrative personnel of the entity have complete access to and control over the configuration, management, and security of the self-managed network 1800 and its resources.

The self-managed network 1800 can execute one or more instances of the data intake and query system. An instance of the data intake and query system may be executed by one or more computing devices that are part of the self-managed network 1800. A data intake and query system instance can comprise an indexing system and a search system, where the indexing system includes one or more indexers 1820 and the search system includes one or more search heads 1860.

As depicted in FIG. 18, the self-managed network 1800 can include one or more data sources 1802. Data received from these data sources may be processed by an instance of the data intake and query system within self-managed network 1800. The data sources 1802 and the data intake and query system instance can be communicatively coupled to each other via a private network 1810.

Users associated with the entity can interact with and avail themselves of the functions performed by a data intake and query system instance using computing devices. As depicted in FIG. 18, a computing device 1804 can execute a network access application 1806 (e.g., a web browser), that can communicate with the data intake and query system instance and with data sources 1802 via the private network 1810. Using the computing device 1804, a user can perform various operations with respect to the data intake and query system, such as management and administration of the data intake and query system, generation of knowledge objects, and other functions. Results generated from processing performed by the data intake and query system instance may be communicated to the computing device 1804 and output to the user via an output system (e.g., a screen) of the computing device 1804.

The self-managed network 1800 can also be connected to other networks that are outside the entity's on-premise environment/network, such as networks outside the entity's data center. Connectivity to these other external networks is controlled and regulated through one or more layers of security provided by the self-managed network 1800. One or more of these security layers can be implemented using firewalls 1812. The firewalls 1812 form a layer of security around the self-managed network 1800 and regulate the transmission of traffic from the self-managed network 1800 to the other networks and from these other networks to the self-managed network 1800.

Networks external to the self-managed network can include various types of networks including public networks 1890, other private networks, and/or cloud networks provided by one or more cloud service providers. An example of a public network 1890 is the Internet. In the example depicted in FIG. 18, the self-managed network 1800 is connected to a service provider network 1892 provided by a cloud service provider via the public network 1890.

In some implementations, resources provided by a cloud service provider may be used to facilitate the configuration and management of resources within the self-managed network 1800. For example, configuration and management of a data intake and query system instance in the self-managed network 1800 may be facilitated by a software management system 1894 operating in the service provider network 1892. There are various ways in which the software management system 1894 can facilitate the configuration and management of a data intake and query system instance within the self-managed network 1800. As one example, the software management system 1894 may facilitate the download of software including software updates for the data intake and query system. In this example, the software management system 1894 may store information indicative of the versions of the various data intake and query system instances present in the self-managed network 1800. When a software patch or upgrade is available for an instance, the software management system 1894 may inform the self-managed network 1800 of the patch or upgrade. This can be done via messages communicated from the software management system 1894 to the self-managed network 1800.

The software management system 1894 may also provide simplified ways for the patches and/or upgrades to be downloaded and applied to the self-managed network 1800. For example, a message communicated from the software management system 1894 to the self-managed network 1800 regarding a software upgrade may include a Uniform Resource Identifier (URI) that can be used by a system administrator of the self-managed network 1800 to download the upgrade to the self-managed network 1800. In this manner, management resources provided by a cloud service provider using the service provider network 1892 and which are located outside the self-managed network 1800 can be used to facilitate the configuration and management of one or more resources within the entity's on-prem environment. In some implementations, the download of the upgrades and patches may be automated, whereby the software management system 1894 is authorized to, upon determining that a patch is applicable to a data intake and query system instance inside the self-managed network 1800, automatically communicate the upgrade or patch to self-managed network 1800 and cause it to be installed within self-managed network 1800.

### IV. Additional Considerations

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A method, comprising:
obtaining a data set pertaining to a first time window;
performing feature extraction operations resulting in generation of extracted features according to the first time window;
performing aggregation operations for each feature of the extracted features with corresponding historical features over a second time window resulting in a set of aggregated features over the second time window through execution of a statistical computation;
performing feature engineering on the aggregated features over a third time window on a per entity basis resulting in generation of set of feature vectors;
performing an anomaly detection process on the set of feature vectors including providing the set of feature vectors as input to a machine learning model resulting in generation of a label for each feature vector of the set of features; and
performing a remedial action determination process including performing a threshold comparison with each label and, responsive to satisfaction of the threshold comparison by a first label, causing performance of one or more remedial actions.

2. The method of claim 1, wherein performing the feature aggregation operations are performed on a rolling window.

3. The method of claim 1, wherein the extracted features consist of mergeable features configured to be aggregated with corresponding past extracted features over the second time window.

4. The method of claim 1, wherein each entity represents a user or a device.

5. The method of claim 1, wherein the extracted features generated by the feature extraction operations are stored in a first summary data store configured to be accessible to logic that is configured to perform the aggregation operations.

6. The method of claim 1, wherein the first time window is one hour and obtaining subsequent data sets pertaining to the first time window is performed at regular one hour intervals.

7. The method of claim 6, wherein the second time window is 24 hours, and the third time window is 30 days.

8. A computing device, comprising:
a processor; and
a non-transitory computer-readable medium having stored thereon instructions that, when executed by the processor, cause the processor to perform operations including:
obtaining a data set pertaining to a first time window,
performing feature extraction operations resulting in generation of extracted features according to the first time window,
performing aggregation operations for each feature of the extracted features with corresponding historical features over a second time window resulting in a set of aggregated features over the second time window through execution of a statistical computation,
performing feature engineering on the aggregated features over a third time window on a per entity basis resulting in generation of set of feature vectors,
performing an anomaly detection process on the set of feature vectors including providing the set of feature vectors as input to a machine learning model resulting in generation of a label for each feature vector of the set of features, and
performing a remedial action determination process including performing a threshold comparison with each label and, responsive to satisfaction of the threshold comparison by a first label, causing performance of one or more remedial actions.

9. The computing device of claim 8, wherein performing the feature aggregation operations are performed on a rolling window.

10. The computing device of claim 8, wherein the extracted features consist of mergeable features configured to be aggregated with corresponding past extracted features over the second time window.

11. The computing device of claim 8, wherein each entity represents a user or a device.

12. The computing device of claim 8, wherein the extracted features generated by the feature extraction operations are stored in a first summary data store configured to be accessible to logic that is configured to perform the aggregation operations.

13. The computing device of claim 8, wherein the first time window is one hour and obtaining subsequent data sets pertaining to the first time window is performed at regular one hour intervals.

14. The computing device of claim 13, wherein the second time window is 24 hours, and the third time window is 30 days.

15. A non-transitory computer-readable medium having stored thereon instructions that, when executed by one or more processors, cause the one or more processor to perform operations including:
obtaining a data set pertaining to a first time window;
performing feature extraction operations resulting in generation of extracted features according to the first time window;
performing aggregation operations for each feature of the extracted features with corresponding historical features over a second time window resulting in a set of aggregated features over the second time window through execution of a statistical computation;
performing feature engineering on the aggregated features over a third time window on a per entity basis resulting in generation of set of feature vectors;
performing an anomaly detection process on the set of feature vectors including providing the set of feature vectors as input to a machine learning model resulting in generation of a label for each feature vector of the set of features; and
performing a remedial action determination process including performing a threshold comparison with each label and, responsive to satisfaction of the threshold comparison by a first label, causing performance of one or more remedial actions.

16. The non-transitory computer-readable medium of claim 15, wherein performing the feature aggregation operations are performed on a rolling window.

17. The non-transitory computer-readable medium of claim 15, wherein the extracted features consist of mergeable features configured to be aggregated with corresponding past extracted features over the second time window.

18. The non-transitory computer-readable medium of claim 15, wherein each entity represents a user or a device.

19. The non-transitory computer-readable medium of claim 15, wherein the extracted features generated by the feature extraction operations are stored in a first summary data store configured to be accessible to logic that is configured to perform the aggregation operations.

20. The non-transitory computer-readable medium of claim 15, wherein the first time window is one hour and obtaining subsequent data sets pertaining to the first time window is performed at regular one hour intervals, and wherein the second time window is 24 hours, and the third time window is 30 days.
